(19) United States
(12) Patent Application Publication
(10) Pub. No.: US 2025/0098785 A1
(43) Pub. Date: Mar. 27, 2025

(54) AEROSOL GENERATING DEVICE AND SYSTEM INCLUDING THE SAME

(71) Applicant: KT&G CORPORATION, Daejeon (KR)

(72) Inventors: Yonghwan KIM, Anyang-si, Gyeonggi-do (KR); Dongsung KIM, Seoul (KR); Hunil LIM, Seoul (KR); Seoksu JANG, Daejeon (KR)

(73) Assignee: KT&G CORPORATION, Daejeon (KR)

(21) Appl. No.: 18/723,680

(22) PCT Filed: Dec. 28, 2022
(86) PCT No.: PCT/KR2022/021506

§ 371 Date: Jun. 24, 2024

(30) Foreign Application Priority Data
Dec. 31, 2021 (KR) 10-2021-0194363

(51) Int. Cl. A24F 40/53; A24F 40/57; A24F 40/60; A24F 40/65

(52) U.S. Cl. CPC A24F 40/53; A24F 40/57; A24F 40/60; A24F 40/65

(57) ABSTRACT

An aerosol generating device and a system including the same are provided. The aerosol generating device includes: a heater configured to heat an aerosol generating substance; a communication interface to perform communication with an external device; and a controller, wherein the controller is configured to: in a state where a communication link is established with the external device through the communication interface, check whether authentication for a user is completed; based on the authentication not being completed, restrict use of at least one function including a heating function that supplies power to the heater; and based on the authentication being completed, release a restriction on the use of the at least one function.

### TECHNICAL FIELD

The present disclosure relates to an aerosol generating device and a system including the same.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another objective of the present disclosure to provide an aerosol generating device that can restrict the use by a third party who does not have access to the aerosol generating device, and a system including the same.

It is yet another objective of the present disclosure to provide an aerosol generating device that can provide a user with not only a function of generating an aerosol but also various convenience functions, and a system including the same.

It is yet another objective of the present disclosure to provide an aerosol generating device that can provide a user with a convenience function using a communication link established between an external device and the aerosol generating device, and a system including the same.

### Technical Solution

According to one aspect of the subject matter described in this application, an aerosol generating device includes: a heater configured to heat an aerosol generating substance; a communication interface to perform communication with an external device; and a controller, wherein the controller is configured to: in a state where a communication link is established with the external device through the communication interface, check whether authentication for a user is completed; based on the authentication not being completed, restrict use of at least one function including a heating function that supplies power to the heater; and based on the authentication being completed, release a restriction on the use of the at least one function.

According to another aspect of the subject matter described in this application, a system includes: an aerosol generating device; and an external device, wherein the aerosol generating device includes a first communication interface to perform communication with the external device, and the external device includes a second communication interface to perform communication with the aerosol generating device and a memory. The aerosol generating device may be configured to: in a state where a communication link is established with the external device through the first communication interface, check whether authentication for a user is completed; based on the authentication not being completed, restrict use of at least one function; and based on the authentication being completed, release a restriction on the use of the at least one function.

### Advantageous Effects

According to at least one of the embodiments of the present disclosure, the use by a third party who does not have access to an aerosol generating device may be restricted.

According to at least one of the embodiments of the present disclosure, a user may be provided with not only a function of generating an aerosol, but also various convenience functions.

According to at least one of the embodiments of the present disclosure, a user may be provided with a convenience function using a communication link established between an aerosol generating device and an external device.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example

### DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2 to 4 are views for explaining an aerosol-generating device according to embodiments of the present disclosure;

FIGS. 5 and 6 are views for explaining a stick according to embodiments of the present disclosure;

FIG. 7 is a block diagram of an external device according to an embodiment of the present disclosure;

FIG. 8 is a flowchart showing a method of operating an aerosol-generating device according to an embodiment of the present disclosure; and

FIGS. 9A and 22B are views for explaining operation of an aerosol-generating device according to an embodiment of the present disclosure.

### MODE FOR INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

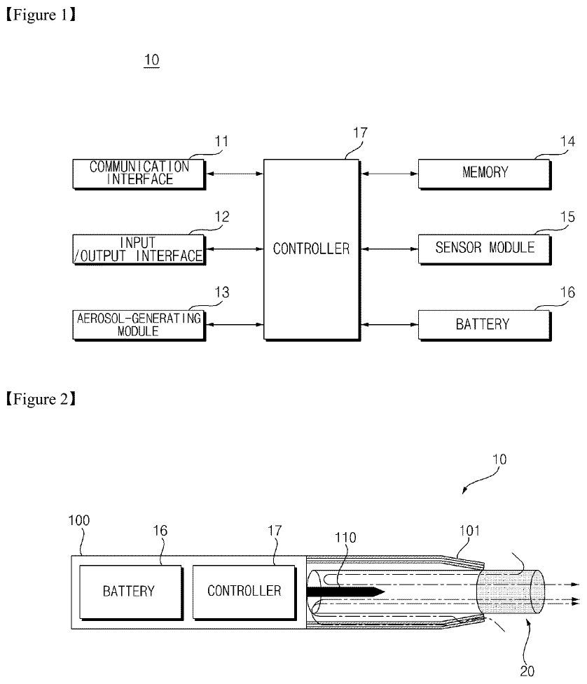

FIG. 1 is a block diagram of an aerosol-generating device according to an embodiment of the present disclosure.

Referring to FIG. 1, an aerosol-generating device 10 may include a communication interface 11, an input/output interface 12, an aerosol-generating module 13, a memory 14, a sensor module 15, a battery 16, and/or a controller 17.

In one embodiment, the aerosol-generating device 10 may be composed only of a main body. In this case, components included in the aerosol-generating device 10 may be located in the main body. In another embodiment, the aerosol-generating device 10 may be composed of a cartridge, which contains an aerosol-generating substance, and a main body. In this case, the components included in the aerosol-generating device 10 may be located in at least one of the main body or the cartridge.

The communication interface 11 may include at least one communication module for communication with an external device and/or a network. For example, the communication interface 11 may include a communication module for wired communication, such as a Universal Serial Bus (USB). For example, the communication interface 11 may include a communication module for wireless communication, such as Wireless Fidelity (Wi-Fi), Bluetooth, Bluetooth Low Energy (BLE), ZigBee, or nearfield communication (NFC).

The input/output device 12 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output device 12 may transmit data corresponding to a command input by the user through the input device to another component (or other components) of the aerosol-generating device 100. The input/output device 12 may output information corresponding to data received from another component (or other components) of the aerosol-generating device 10 through the output device.

The aerosol-generating module 13 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 13 may include at least one heater (not shown).

The aerosol-generating module 13 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 13 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 13 may generate ultrasonic vibrations to thereby generate an aerosol from the aerosol-generating substance.

The aerosol-generating device 10 may be referred to as a cartomizer, an atomizer, or a vaporizer.

The memory 14 may store programs for processing and controlling each signal in the controller 17. The memory 14 may store processed data and data to be processed.

For example, the memory 14 may store applications designed for the purpose of performing various tasks that can be processed by the controller 17. The memory 14 may selectively provide some of the stored applications in response to the request from the controller 17.

For example, the memory 14 may store data on the operation time of the aerosol-generating device 100, the maximum number of puffs, the current number of puffs, the number of uses of battery 16, at least one temperature profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 14 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 15 may include at least one sensor.

For example, the sensor module 15 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 15 may include a sensor for sensing the temperature of the heater included in the aerosol-generating module 13 and the temperature of the aerosol-generating substance (hereinafter referred to as a “temperature sensor”). In this case, the heater included in the aerosol-generating module 13 may also serve as the temperature sensor. For example, the electro-resistive material of the heater may be a material having a predetermined temperature coefficient of resistance. The sensor module 15 may measure the resistance of the heater, which varies according to the temperature, to thereby sense the temperature of the heater.

For example, in the case in which the main body of the aerosol-generating device 10 is formed to allow a stick to be inserted thereinto, the sensor module 15 may include a sensor for sensing insertion of the stick (hereinafter referred to as a “stick detection sensor”).

For example, in the case in which the aerosol-generating device 10 includes a cartridge, the sensor module 15 may include a sensor for sensing mounting/demounting of the cartridge and the position of the cartridge (hereinafter referred to as a “cartridge detection sensor”).

In this case, the stick detection sensor and/or the cartridge detection sensor may be implemented as an inductance-based sensor, a capacitive sensor, a resistance sensor, or a Hall sensor (or Hall IC) using a Hall effect.

For example, the sensor module 15 may include a voltage sensor for sensing a voltage applied to a component (e.g. the battery 16) provided in the aerosol-generating device 10 and/or a current sensor for sensing a current.

The battery 16 may supply electric power used for the operation of the aerosol-generating device 10 under the control of the controller 17. The battery 16 may supply electric power to other components provided in the aerosol-generating device 100. For example, the battery 16 may supply electric power to the communication module included in the communication interface 11, the output device included in the input/output interface 12, and the heater included in the aerosol-generating module 13.

The battery 16 may be a rechargeable battery or a disposable battery. For example, the battery 16 may be a lithium-ion (Li-ion) battery or a lithium polymer (Li-polymer) battery. However, the present disclosure is not limited thereto. For example, when the battery 16 is rechargeable, the charging rate (C-rate) of the battery 16 may be 10 C, and the discharging rate (C-rate) thereof may be 10 C to 20 C. However, the present disclosure is not limited thereto. Also, for stable use, the battery 16 may be manufactured such that 80% or more of the total capacity may be ensured even when charging/discharging is performed 2000 times.

The aerosol-generating device 10 may further include a protection circuit module (PCM) (not shown), which is a circuit for protecting the battery 16. The protection circuit module (PCM) may be disposed adjacent to the upper surface of the battery 16. For example, in order to prevent overcharging and overdischarging of the battery 16, the protection circuit module (PCM) may cut off the electrical path to the battery 16 when a short circuit occurs in a circuit connected to the battery 16, when an overvoltage is applied to the battery 16, or when an overcurrent flows through the battery 16.

The aerosol-generating device 10 may further include a charging terminal to which electric power supplied from the outside is input. For example, the charging terminal may be formed at one side of the main body of the aerosol-generating device 100. The aerosol-generating device 10 may charge the battery 16 using electric power supplied through the charging terminal. In this case, the charging terminal may be configured as a wired terminal for USB communication, a pogo pin, or the like.

The aerosol-generating device 10 may further include a power terminal (not shown) to which electric power supplied from the outside is input. For example, a power line may be connected to the power terminal, which is disposed at one side of the main body of the aerosol-generating device 100. The aerosol-generating device 10 may use the electric power supplied through the power line connected to the power terminal to charge the battery 16. In this case, the power terminal may be a wired terminal for USB communication.

The aerosol-generating device 10 may wirelessly receive electric power supplied from the outside through the communication interface 11. For example, the aerosol-generating device 10 may wirelessly receive electric power using an antenna included in the communication module for wireless communication. The aerosol-generating device 10 may charge the battery 16 using the wirelessly supplied electric power.

The controller 17 may control the overall operation of the aerosol-generating device 100. The controller 17 may be connected to each of the components provided in the aerosol-generating device 100. The controller 17 may transmit and/or receive a signal to and/or from each of the components, thereby controlling the overall operation of each of the components.

The controller 17 may include at least one processor. The controller 17 may control the overall operation of the aerosol-generating device 10 using the processor included therein. Here, the processor may be a general processor such as a central processing unit (CPU). Of course, the processor may be a dedicated device such as an application-specific integrated circuit (ASIC), or may be any of other hardware-based processors.

The controller 17 may perform any one of a plurality of functions of the aerosol-generating device 100. For example, the controller 17 may perform any one of a plurality of functions of the aerosol-generating device 10 (e.g. a preheating function, a heating function, a charging function, and a cleaning function) according to the state of each of the components provided in the aerosol-generating device 10 and the user's command received through the input/output interface 12.

The controller 17 may control the operation of each of the components provided in the aerosol-generating device 10 based on data stored in the memory 14. For example, the controller 17 may control the supply of a predetermined amount of electric power from the battery 16 to the aerosol-generating module 13 for a predetermined time based on the data on the temperature profile, the user's inhalation pattern, which is stored in the memory 14.

The controller 17 may determine the occurrence or non-occurrence of a puff using the puff sensor included in the sensor module 15. For example, the controller 17 may check a temperature change, a flow change, a pressure change, and a voltage change in the aerosol-generating device 10 based on the values sensed by the puff sensor. The controller 17 may determine the occurrence or non-occurrence of a puff based on the value sensed by the puff sensor.

The controller 17 may control the operation of each of the components provided in the aerosol-generating device 10 according to the occurrence or non-occurrence of a puff and/or the number of puffs. For example, the controller 17 may perform control such that the temperature of the heater is changed or maintained based on the temperature profile stored in the memory 14.

The controller 17 may perform control such that the supply of electric power to the heater is interrupted according to a predetermined condition. For example, the controller 17 may perform control such that the supply of electric power to the heater is interrupted when the stick is removed, when the cartridge is demounted, when the number of puffs reaches the predetermined maximum number of puffs, when a puff is not sensed during a predetermined period of time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on the values sensed by the voltage sensor and/or the current sensor included in the sensor module 15.

The controller 17 may perform control such that electric power is supplied to the heater using at least one of a pulse width modulation (PWM) method or a proportional-integral-differential (PID) method.

For example, the controller 17 may perform control such that a current pulse having a predetermined frequency and a predetermined duty ratio is supplied to the heater using the PWM method. In this case, the controller 17 may control the amount of electric power supplied to the heater by adjusting the frequency and the duty ratio of the current pulse.

For example, the controller 17 may determine a target temperature to be controlled based on the temperature profile. In this case, the controller 17 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

Meanwhile, the controller 17 may perform control such that electric power is supplied to the heater according to a predetermined condition. For example, when a cleaning function for cleaning the space into which the stick is inserted is selected in response to a command input by the user through the input/output interface 12, the controller 17 may perform control such that a predetermined amount of electric power is supplied to the heater.

FIGS. 2 to 4 are views for explaining an aerosol-generating device according to embodiments of the present disclosure.

According to various embodiments of the present disclosure, the aerosol-generating device 10 may include a main body 100 and/or a cartridge 200.

Referring to FIG. 2, the aerosol-generating device 10 according to an embodiment may include a main body 100, which is formed such that a stick 20 can be inserted into the inner space formed by a housing 101.

The stick 20 may be similar to a general combustive cigarette. For example, the stick 20 may be divided into a first portion including an aerosol generating material and a second portion including a filter and the like. Alternatively, an aerosol generating material may be included in the second portion of the stick 20. For example, a flavoring substance made in the form of granules or capsules may be inserted into the second portion.

The entire first portion is inserted into the insertion space of the aerosol-generating device 10, and the second portion may be exposed to the outside. Alternatively, only a portion of the first portion may be inserted into the insertion space of the aerosol-generating device 10, or a portion of the first portion and the second portion may be inserted. In this case, the aerosol may be generated by passing external air through the first portion, and the generated aerosol may be delivered to the user's mouth through the second portion.

The main body 100 may be structured such that external air is introduced into the main body 100 in the state in which the stick 20 is inserted thereinto. In this case, the external air introduced into the main body 100 may flow into the mouth of the user via the stick 20.

The heater may be disposed in the main body 100 at a position corresponding to the position at which the stick 20 is inserted into the main body 100. Although it is illustrated in the drawings that the heater is an electrically conductive heater 110 including a needle-shaped electrically conductive track, the present disclosure is not limited thereto.

The heater may heat the interior and/or exterior of the stick 20 using the electric power supplied from the battery 16. An aerosol may be generated from the heated stick 20. At this time, the user may hold one end of the stick 20 in the mouth to inhale the aerosol containing a tobacco material.

Meanwhile, the controller 17 may perform control such that electric power is supplied to the heater in the state in which the stick 20 is not inserted into the main body according to a predetermined condition. For example, when a cleaning function for cleaning the space into which the stick 20 is inserted is selected in response to a command input by the user through the input/output interface 12, the controller 17 may perform control such that a predetermined amount of electric power is supplied to the heater.

The controller 17 may monitor the number of puffs based on the value sensed by the puff sensor from the point in time at which the stick 20 was inserted into the main body.

When the stick 20 is removed from the main body, the controller 17 may initialize the current number of puffs stored in the memory 14.

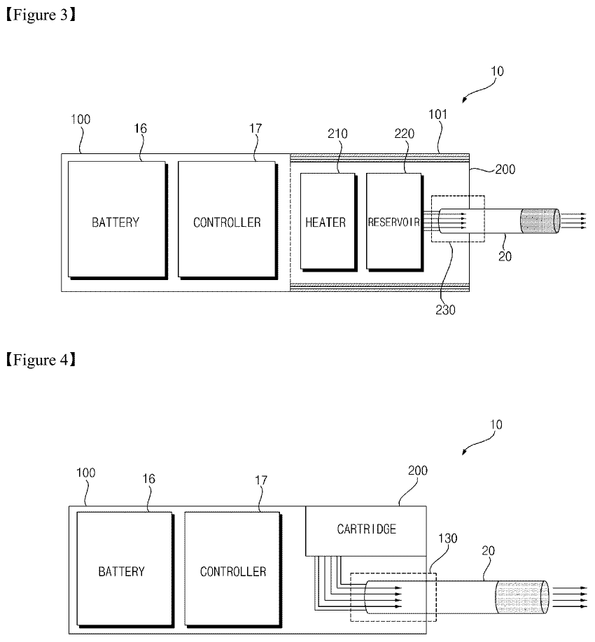

Referring to FIG. 3, the aerosol-generating device 10 according to an embodiment may include a main body 100 and a cartridge 200. The main body 100 may support the cartridge 200, and the cartridge 200 may contain an aerosol-generating substance.

According to one embodiment, the cartridge 200 may be configured so as to be detachably mounted to the main body 100. According to another embodiment, the cartridge 200 may be integrally configured with the main body 100. For example, the cartridge 200 may be mounted to the main body 100 in a manner such that at least a portion of the cartridge 200 is inserted into the insertion space formed by a housing 101 of the main body 100.

The main body 100 may be formed to have a structure in which external air can be introduced into the main body 100 in the state in which the cartridge 200 is inserted thereinto. Here, the external air introduced into the main body 100 may flow into the user's mouth via the cartridge 200.

The controller 17 may determine whether the cartridge 200 is in a mounted state or a detached state using a cartridge detection sensor included in the sensor module 15. For example, the cartridge detection sensor may transmit a pulse current through a first terminal connected with the cartridge 200. In this case, the controller 17 may determine whether the cartridge 200 is in a connected state, based on whether the pulse current is received through a second terminal.

The cartridge 200 may include a heater 210 configured to heat the aerosol-generating substance and/or a reservoir 220 configured to contain the aerosol-generating substance. For example, a liquid delivery element impregnated with (containing) the aerosol-generating substance may be disposed inside the reservoir 220. The electrically conductive track of the heater 210 may be formed in a structure that is wound around the liquid delivery element. In this case, when the liquid delivery element is heated by the heater 210, an aerosol may be generated. Here, the liquid delivery element may include a wick made of, for example, cotton fiber, ceramic fiber, glass fiber, or porous ceramic.

The cartridge 200 may include an insertion space 230 configured to allow the stick 20 to be inserted. For example, the cartridge 200 may include the insertion space formed by an inner wall extending in a circumferential direction along a direction in which the stick 20 is inserted. In this case, the insertion space may be formed by opening the inner side of the inner wall up and down. The stick 20 may be inserted into the insertion space formed by the inner wall.

The insertion space into which the stick 20 is inserted may be formed in a shape corresponding to the shape of a portion of the stick 20 inserted into the insertion space. For example, when the stick 20 is formed in a cylindrical shape, the insertion space may be formed in a cylindrical shape.

When the stick 20 is inserted into the insertion space, the outer surface of the stick 20 may be surrounded by the inner wall and contact the inner wall.

A portion of the stick 20 may be inserted into the insertion space, the remaining portion of the stick 20 may be exposed to the outside.

The user may inhale the aerosol while biting one end of the stick 20 with the mouth. The aerosol generated by the heater 210 may pass through the stick 20 and be delivered to the user's mouth. At this time, while the aerosol passes through the stick 20, the material contained in the stick 20 may be added to the aerosol. The material-infused aerosol may be inhaled into the user's oral cavity through the one end of the stick 20.

Referring to FIG. 4, the aerosol-generating device 10 according to an embodiment may include a main body 100 supporting the cartridge 200 and a cartridge 200 containing an aerosol-generating substance. The main body 100 may be formed so as to allow the stick 20 to be inserted into an insertion space 1300 therein.

The aerosol-generating device 10 may include a first heater for heating the aerosol-generating substance stored in the cartridge 200. For example, when the user holds one end of the stick 20 in the mouth to inhale the aerosol, the aerosol generated by the first heater may pass through the stick 20. At this time, while the aerosol passes through the stick 20, a flavor may be added to the aerosol. The aerosol containing the flavor may be drawn into the user's oral cavity through one end of the stick 20.

Alternatively, according to another embodiment, the aerosol-generating device 10 may include a first heater for heating the aerosol-generating substance stored in the cartridge 200 and a second heater for heating the stick 20 inserted into the main body 100. For example, the aerosol-generating device 10 may generate an aerosol by heating the aerosol-generating substance stored in the cartridge 200 and the stick 20 using the first heater and the second heater, respectively.

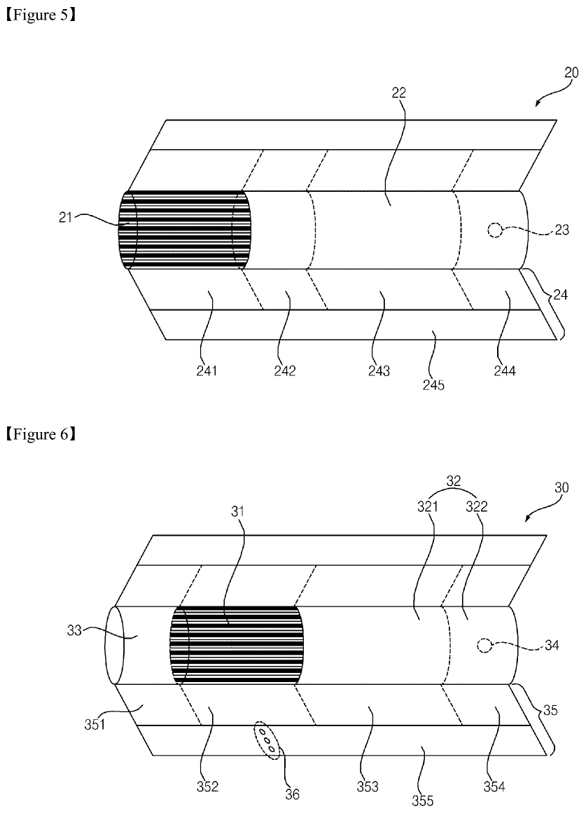

FIGS. 5 and 6 are views for explaining a stick according to embodiments of the present disclosure.

Referring to FIG. 5, the stick 20 may include a tobacco rod 21 and a filter rod 22. The first portion described above with reference to FIG. 2 may include the tobacco rod. The second portion described above with reference to FIG. 2 may include the filter rod 22.

FIG. 5 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

A diameter of the stick 20 may be within a range of 5 mm to 9 mm, and a length of the stick 20 may be about 48 mm, but embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm, but embodiments are not limited thereto.

The stick 20 may be wrapped using at least one wrapper 24. The wrapper 24 may have at least one hole through which external air may be introduced or internal air may be discharged. For example, the stick 20 may be wrapped using one wrapper 24. As another example, the stick 20 may be double-wrapped using at least two wrappers 24. For example, the tobacco rod 21 may be wrapped using a first wrapper 241. For example, the filter rod 22 may be wrapped using wrappers 242, 243, 244. The tobacco rod 21 and the filter rod 22 wrapped by wrappers may be combined. The stick 20 may be re-wrapped by a single wrapper 245. When each of the tobacco rod 21 and the filter rod 22 includes a plurality of segments, each segment may be wrapped using wrappers 242, 243, 244. The entirety of stick 20 composed of a plurality of segments wrapped by wrappers may be re-wrapped by another wrapper

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and an aluminum laminate packaging material.

The third wrapper 243 may be made of a hard wrapping paper. For example, a basis weight of the third wrapper 243 may be within a range of 88 g/m2 to 96 g/m2. For example, the basis weight of the third wrapper 243 may be within a range of 90 g/m2 to 94 g/m2. Also, a total thickness of the third wrapper 243 may be within a range of 1200 μm to 1300 μm. For example, the total thickness of the third wrapper 243 may be 125 μm.

The fourth wrapper 244 may be made of an oil-resistant hard wrapping paper. For example, a basis weight of the fourth wrapper 244 may be within a range of about 88 g/m2 to about 96 g/m2. For example, the basis weight of the fourth wrapper 244 may be within a range of 90 g/m2 to 94 g/m2. Also, a total thickness of the fourth wrapper 244 may be within a range of 1200 μm to 1300 μm. For example, the total thickness of the fourth wrapper 244 may be 125 μm.

The fifth wrapper 245 may be made of a sterilized paper (MFW). Here, the MFW refers to a paper specially manufactured to have enhanced tensile strength, water resistance, smoothness, and the like, compared to ordinary paper. For example, a basis weight of the fifth wrapper 245 may be within a range of 57 g/m2 to 63 g/m2. For example, a basis weight of the fifth wrapper 245 may be about 60 g/m2. Also, the total thickness of the fifth wrapper 245 may be within a range of 64 μm to 70 μm. For example, the total thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the stick 20 from being burned. For example, when the tobacco rod 21 is heated by the heater 110, there is a possibility that the stick 20 is burned. In detail, when the temperature is raised to a temperature above the ignition point of any one of materials included in the tobacco rod 21, the stick 20 may be burned. Even in this case, since the fifth wrapper 245 include a non-combustible material, the burning of the stick 20 may be prevented.

Furthermore, the fifth wrapper 245 may prevent the aerosol generating device 100 from being contaminated by substances formed by the stick 20. Through puffs of a user, liquid substances may be formed in the stick 20. For example, as the aerosol formed by the stick 20 is cooled by the outside air, liquid materials (e.g., moisture, etc.) may be formed. As the fifth wrapper 245 wraps the stick 20, the liquid materials formed in the stick 20 may be prevented from being leaked out of the stick 20.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater.

Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. The first segment may prevent an internal material of the tobacco rod 21 from being pushed back when the heater 110 is inserted into the tobacco rod 21 and may also provide a cooling effect to aerosol. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm but is not limited thereto.

The second segment of the filter rod 22 cools the aerosol which is generated when the heater 110 heats the tobacco rod 21. Therefore, the user may puff the aerosol which is cooled at an appropriate temperature.

The length or diameter of the second segment may be variously determined according to the shape of the stick 20. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulous acetate (CA), and aluminum coil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm2/mm and about 1000 mm2/mm. In addition, an aerosol cooling element may be formed from a material having a specific surface area between about 10 mm2/mg and about 100 mm2/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulous acetate filter. The length of the third segment may be an appropriate length within a range of 4 mm to 20 mm. For example, the length of the third segment may be about 12 mm but is not limited thereto.

The filter rod 22 may be manufactured to generate flavors. For example, a flavoring liquid may be injected onto the filter rod 22. For example, an additional fiber coated with a flavoring liquid may be inserted into the filter rod 22.

Also, the filter rod 22 may include at least one capsule 23. Here, the capsule 23 may generate a flavor. The capsule 23 may generate an aerosol. For example, the capsule 23 may have a configuration in which a liquid including a flavoring material is wrapped with a film. The capsule 23 may have a spherical or cylindrical shape but is not limited thereto.

Referring to FIG. 6, a stick 30 may further include a front-end plug 33. The front-end plug 33 may be located on a side of a tobacco rod 31, the side not facing a filter rod 32. The front-end plug 33 may prevent the tobacco rod 31 from being detached and prevent liquefied aerosol from flowing into the aerosol generating device 10 from the tobacco rod 31, during smoking.

The filter rod 32 may include a first segment 321 and a second segment 322. The first segment 321 may correspond to the first segment of the filter rod 22 of FIG. 4. The segment 322 may correspond to the third segment of the filter rod 22 of FIG. 4.

A diameter and a total length of the stick 30 may correspond to the diameter and a total length of the stick 20 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The stick 30 may be wrapped using at least one wrapper 35. The wrapper 35 may have at least one hole through which external air may be introduced or internal air may be discharged. For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire stick 30 may be re-wrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. For example, the perforation 36 may transfer heat formed by the heater 210 illustrated in FIG. 3 into the tobacco rod 31.

Also, the second segment 322 may include at least one capsule 34. Here, the capsule 34 may generate a flavor. The capsule 34 may generate an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with a metal foil such as an aluminum coil. For example, a total thickness of the first wrapper 351 may be within a range of 45 μm to 55 μm. For example, the total thickness of the first wrapper 351 may be 50.3 μm. Also, a thickness of the metal coil of the first wrapper 351 may be within a range 6 μm to 7 μm. For example, the thickness of the metal coil of the first wrapper 351 may be 6.3 μm. In addition, a basis weight of the first wrapper 351 may be within a range of 50 g/m2 to 55 g/m2. For example, the basis weight of the first wrapper 351 may be 53 g/m2.

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m2 to 25 g/m2. For example, the basis weight of the second wrapper 352 may be 23.5 g/m2.

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m2 to about 25 g/m2. For example, the basis weight of the third wrapper 353 may be 21 g/m2.

The fourth wrapper 354 may be formed of PLA laminated paper. Here, the PLA laminated paper refers to three-layer paper including a paper layer, a PLA layer, and a paper layer. For example, a thickness of the fourth wrapper 353 may be in a range of 100 μm to 1200 μm. For example, the thickness of the fourth wrapper 353 may be 110 μm. Also, a basis weight of the fourth wrapper 354 may be in a range of 80 g/m2 to 100 g/m2. For example, the basis weight of the fourth wrapper 354 may be 88 g/m2.

The fifth wrapper 355 may be formed of sterilized paper (MFW). Here, the sterilized paper (MFW) refers to paper which is particularly manufactured to improve tensile strength, water resistance, smoothness, and the like more than ordinary paper. For example, a basis weight of the fifth wrapper 355 may be in a range of 57 g/m2 to 63 g/m2. For example, the basis weight of the fifth wrapper 355 may be 60 g/m2. Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulous acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a Y shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 4. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a Y shape. Total denier of the second segment 322 may be in a range of 20000 to 30000. For example, the total denier of the second segment 322 may be 25000.

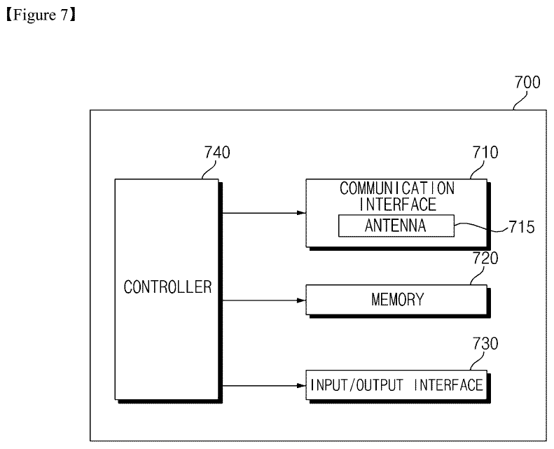

FIG. 7 is a block diagram of an external device according to an embodiment of the present disclosure.

Referring to FIG. 7, an external device 700 may include a communication interface 710, a memory 720, an input/output interface 730, and/or a controller 740.

The communication interface 710 may include at least one communication module for communication with the aerosol generating device 10 and/or a network. For example, the communication interface 710 may include a communication module for wired communication such as USB, recommended standard 232 (RS-232), registered jack-45 (RJ-45), or the like. For example, the communication interface 710 may include a communication module for wireless communication such as Wi-Fi, Bluetooth, Bluetooth Low Energy (BLE), ZigBee, NFC, or the like.

The communication interface 710 may include at least one antenna 715 corresponding to a communication module for wireless communication. The antenna 715 may include an antenna corresponding to Bluetooth, an antenna corresponding to global positioning system (GPS), and the like.

The memory 720 may include at least one non-volatile memory (e.g., a flash memory, a hard disk drive (HDD), a solid-state drive (SSD), and the like).

The memory 720 may store a program for processing and controlling each signal in the controller 740, and may store data processed and data to be processed. Herein, a program and an application may be interchangeably used as necessary.

The memory 720 may store a unique identifier for the external device 700. For example, the identifier for the external device 700 may include a media access control address (MAC address), a serial number, an International Mobile Equipment Identity (IMEI), and the like.

The input/output interface 730 may include an input device that receives a command from a user and/or an output device that outputs information to the user. For example, the input device may include a touch panel, a physical button, and the like. For example, the output device may include a display device that outputs visual information such as a display, an audio device that outputs auditory information such as a speaker, and the like.

The controller 740 may control the overall operation of the external device 700. The controller 740 may be connected to each of the components provided in the external device 700, and may transmit and/or receive a signal to and/or from each other to thereby control the overall operation of each of the components.

The controller 740 may include at least one processor, and may control the overall operation of the external device 700 by using the processor included therein. Here, the processor may be a general processor such as a central processing unit (CPU). Alternatively, the processor may be a dedicated device such as an application-specific integrated circuit (ASIC), or any of other hardware-based processors.

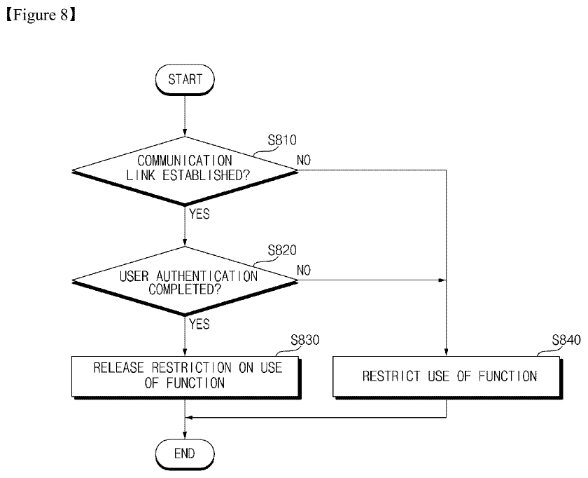

FIG. 8 is a flowchart illustrating a method of operating an aerosol generating device according to an embodiment of the present disclosure.

Referring to FIG. 8, the aerosol generating device 10 may check whether a communication link is established with the external device 700 through the communication interface 11 in operation S810. For example, the aerosol generating device 10 may check whether the communication link is established with the external device 700 through a communication module corresponding to Bluetooth, among the communication modules included in the communication interface 11.

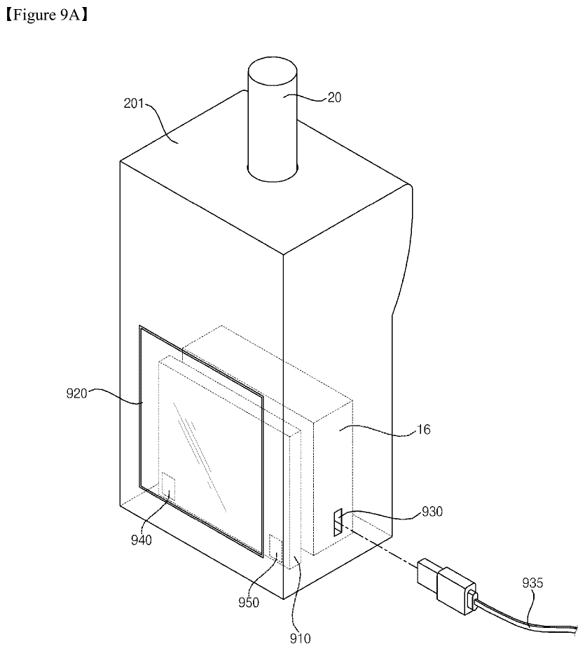

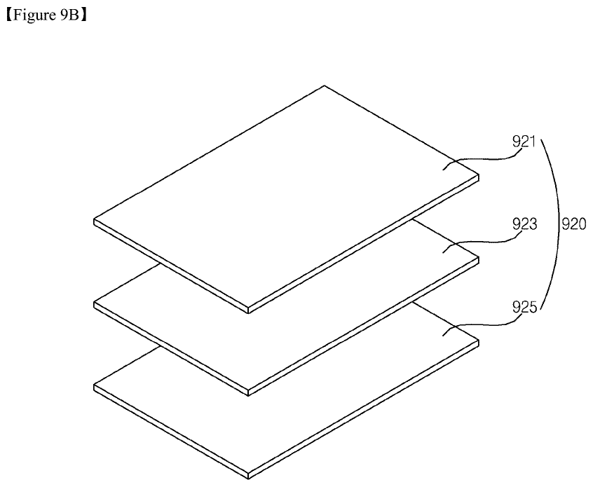

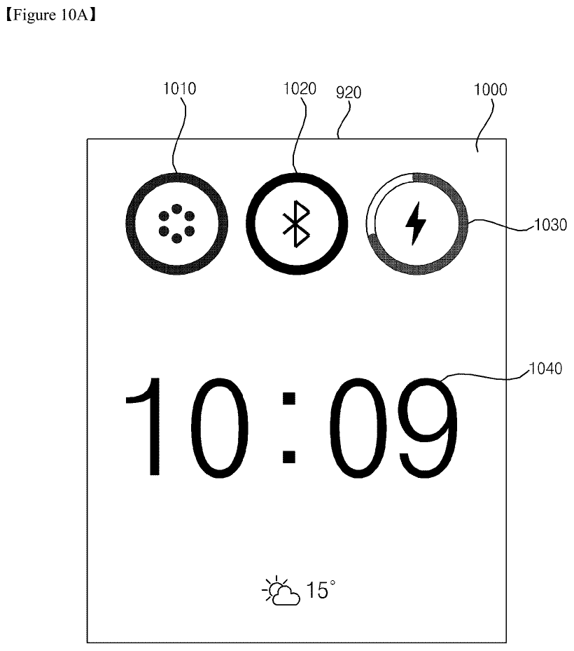

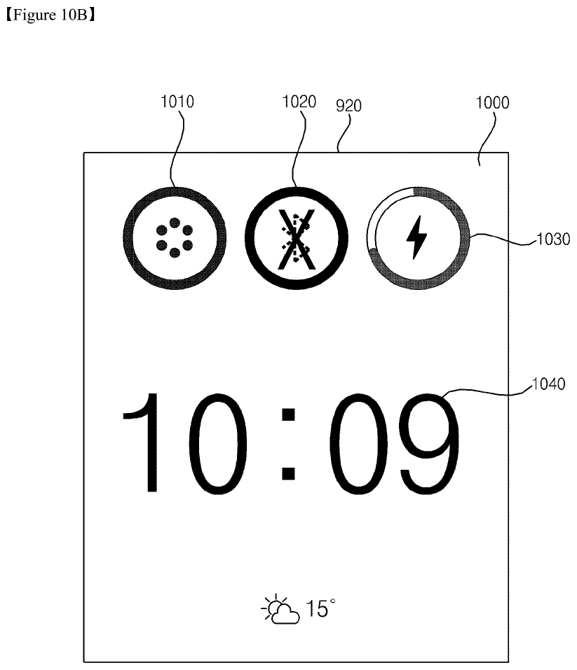

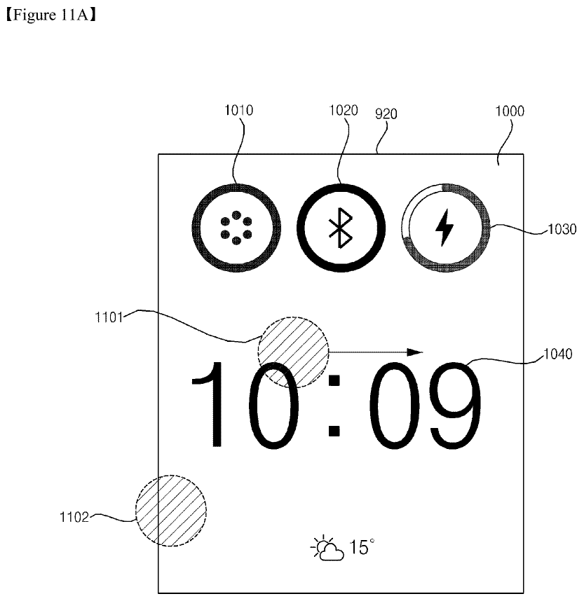

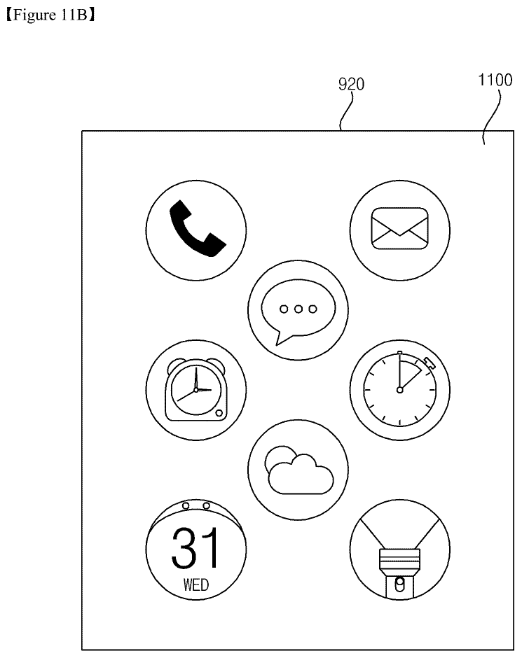

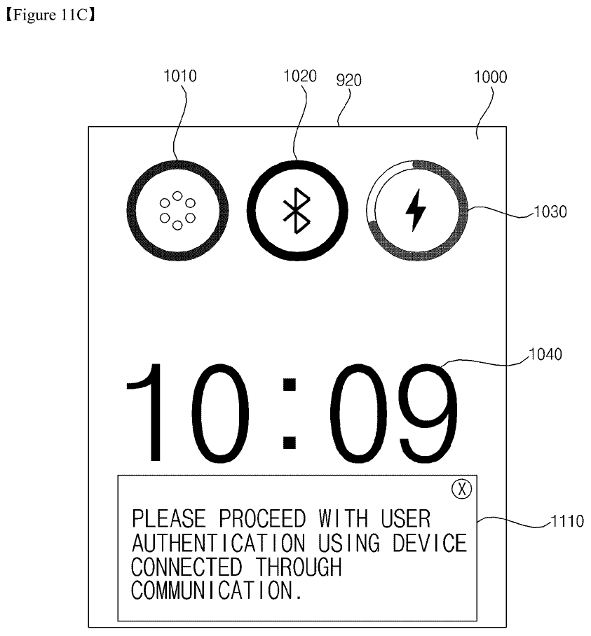

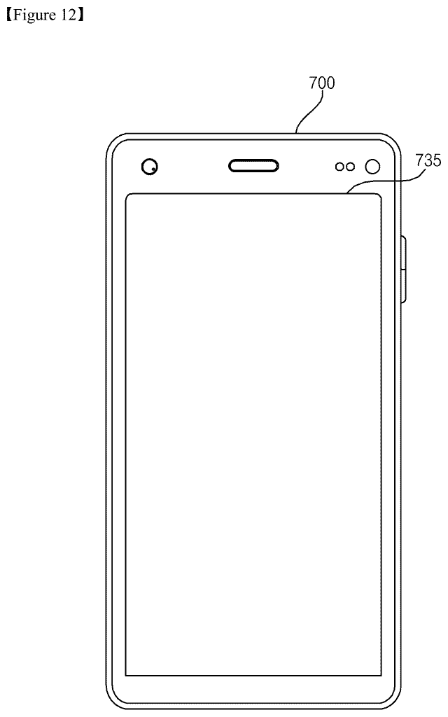

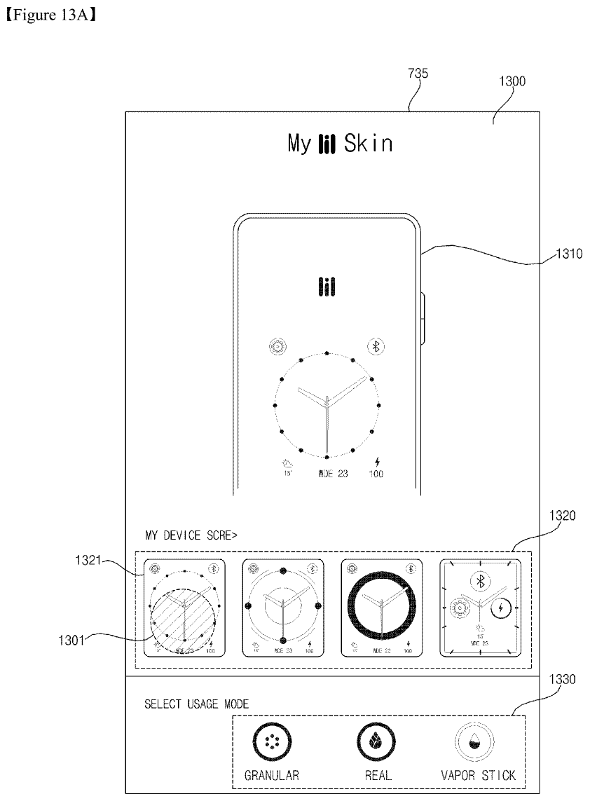

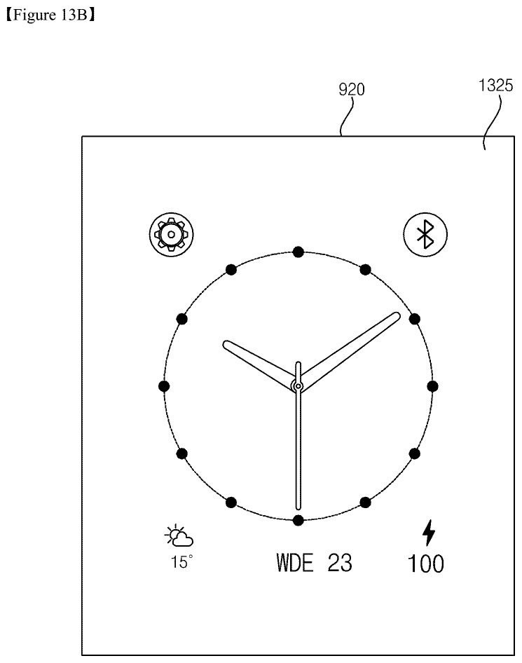

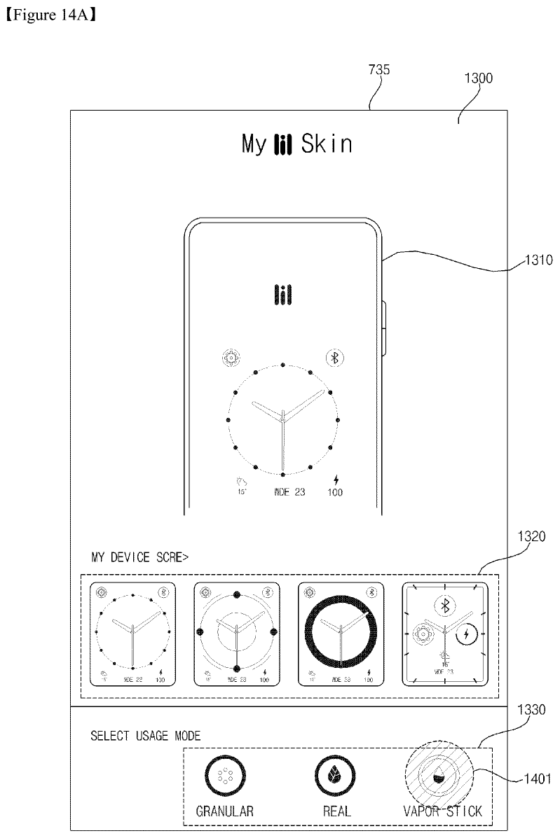

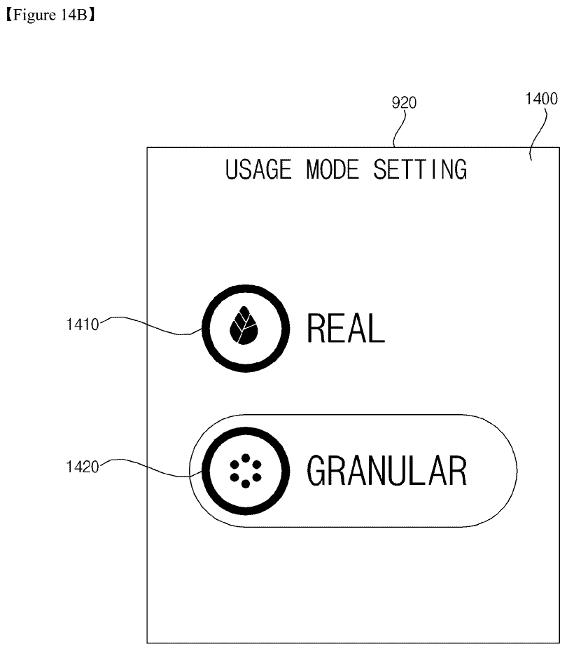

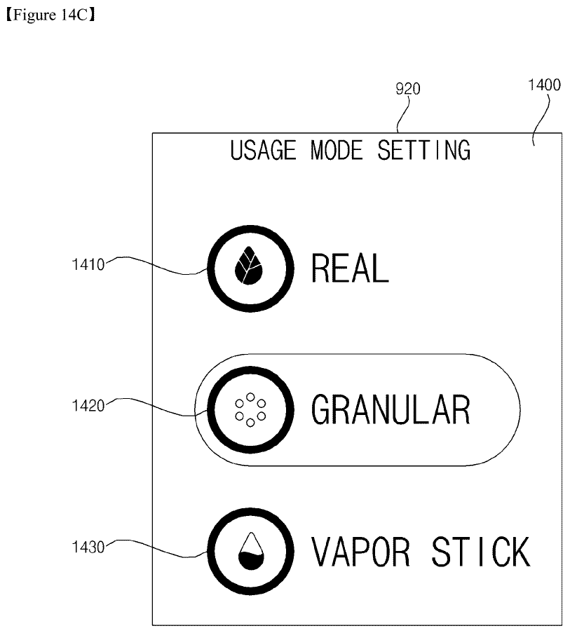

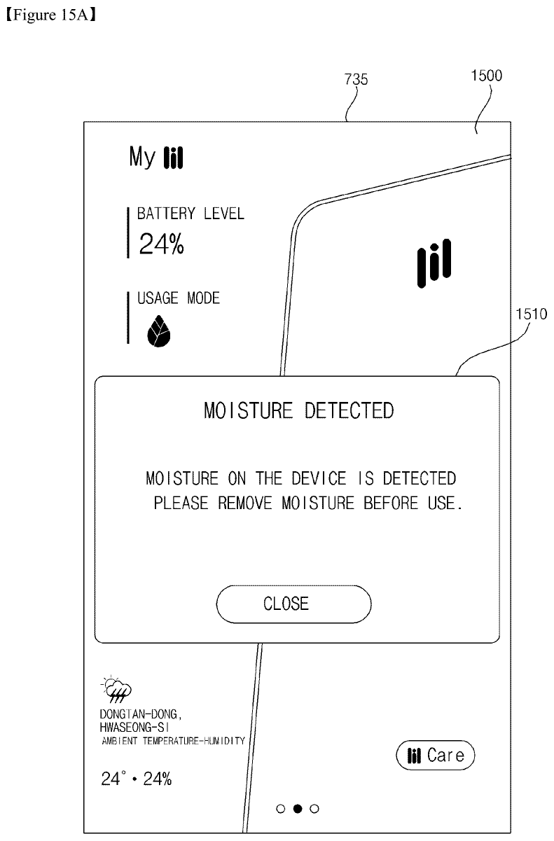

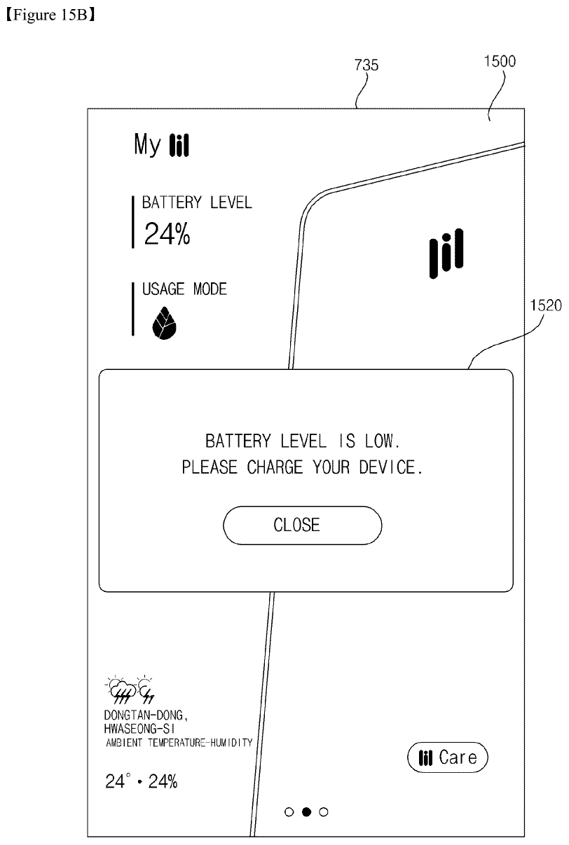

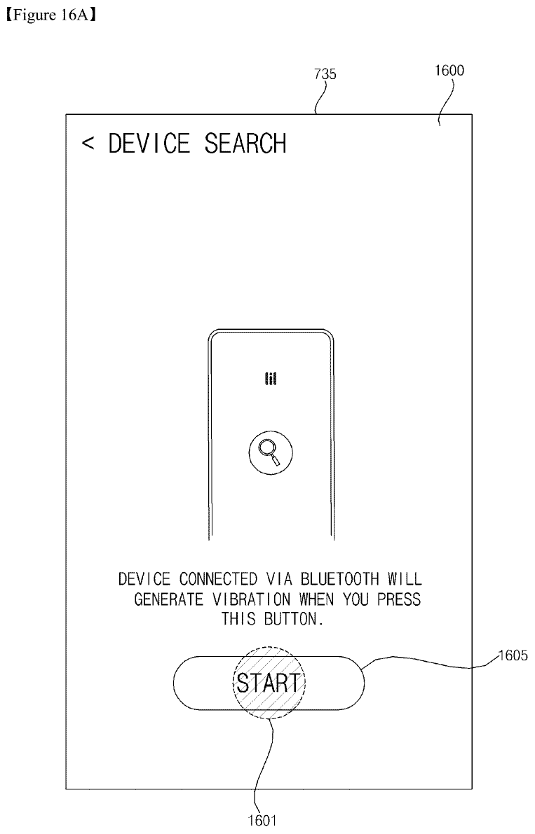

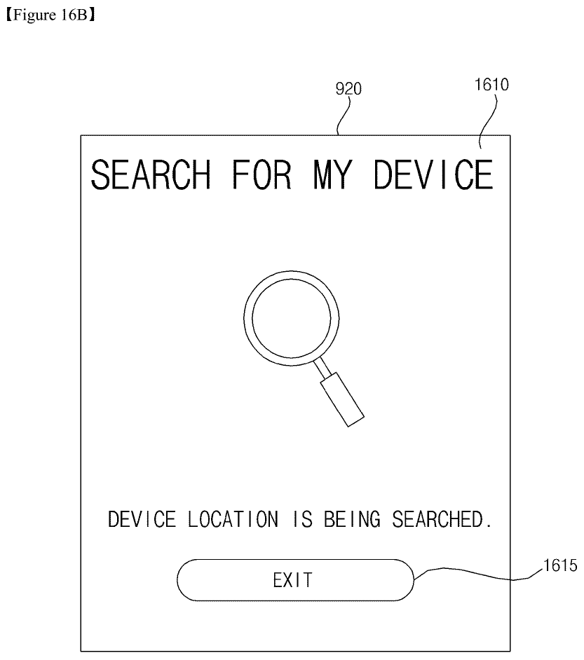

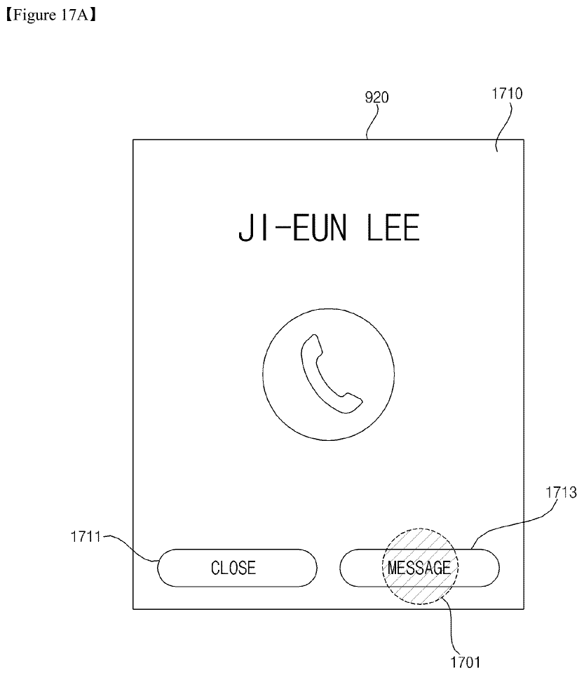

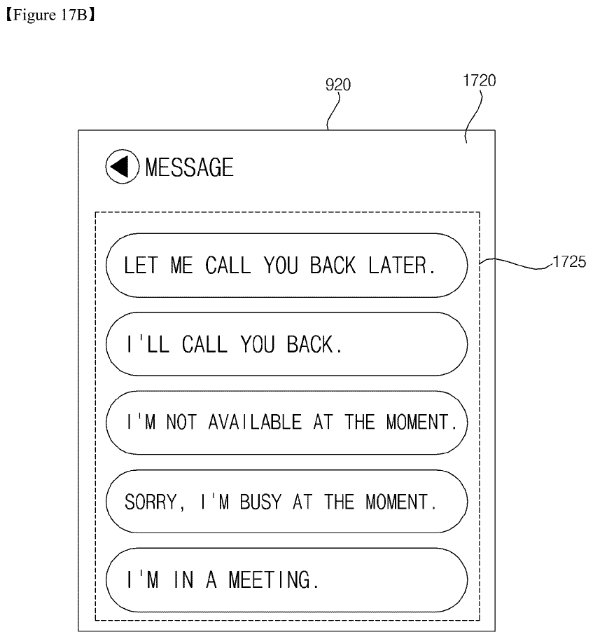

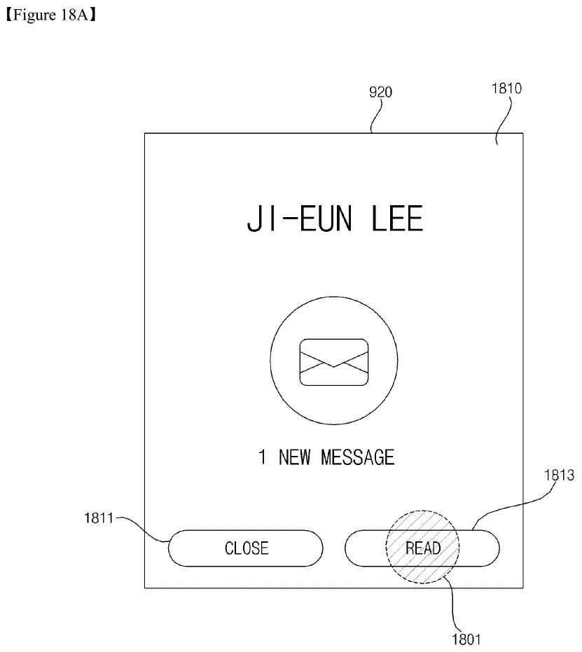

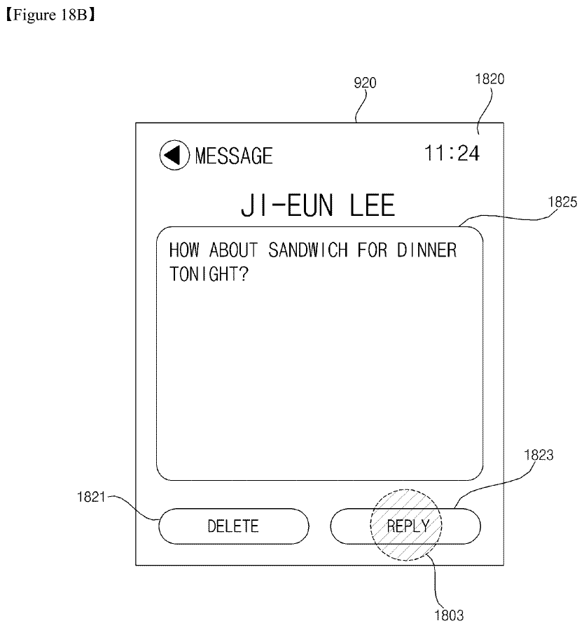

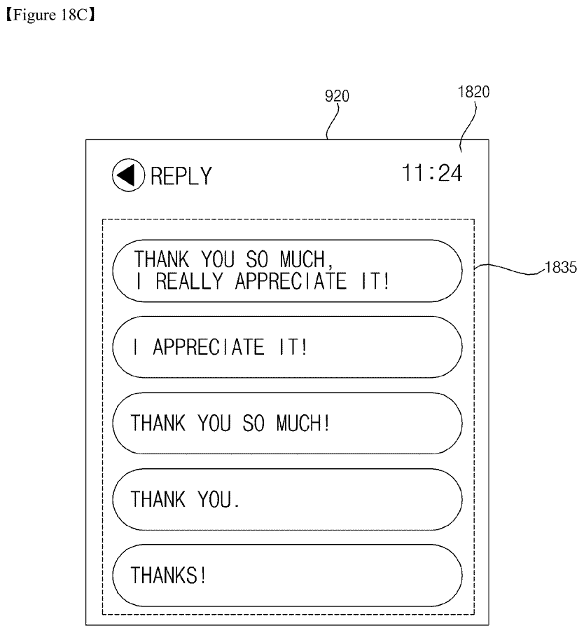

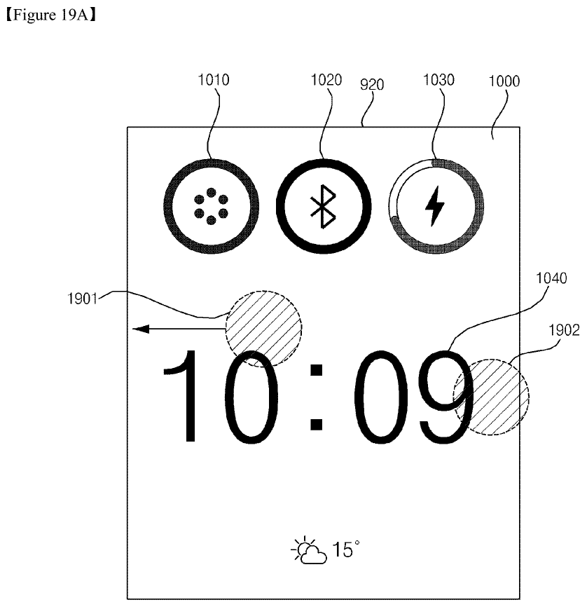

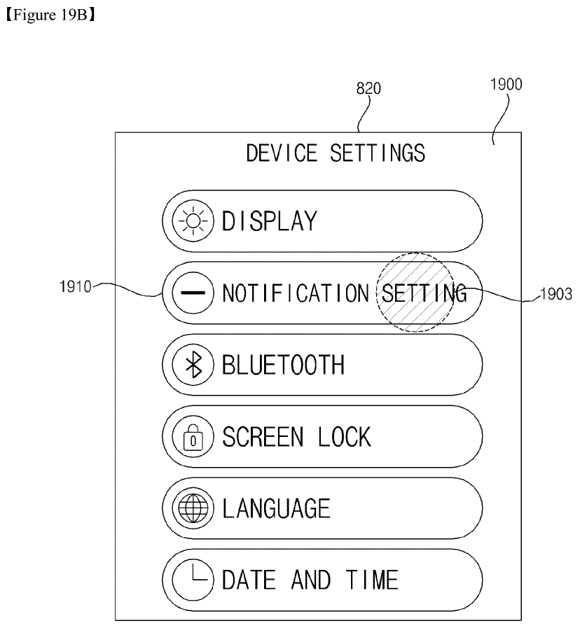

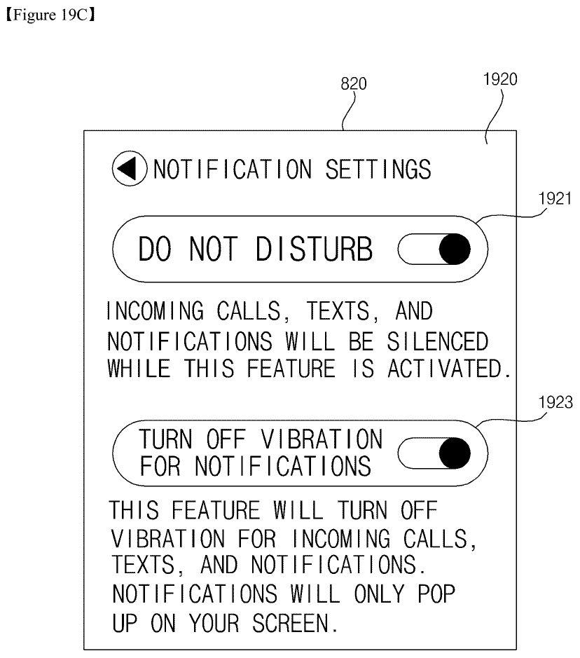

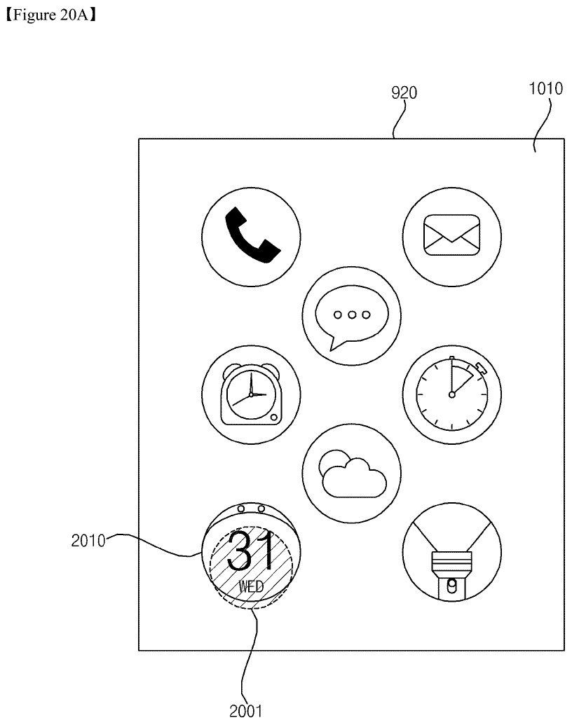

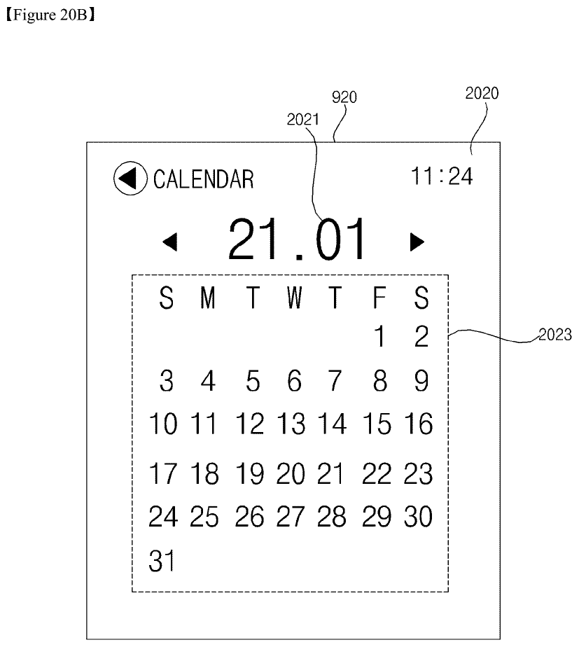

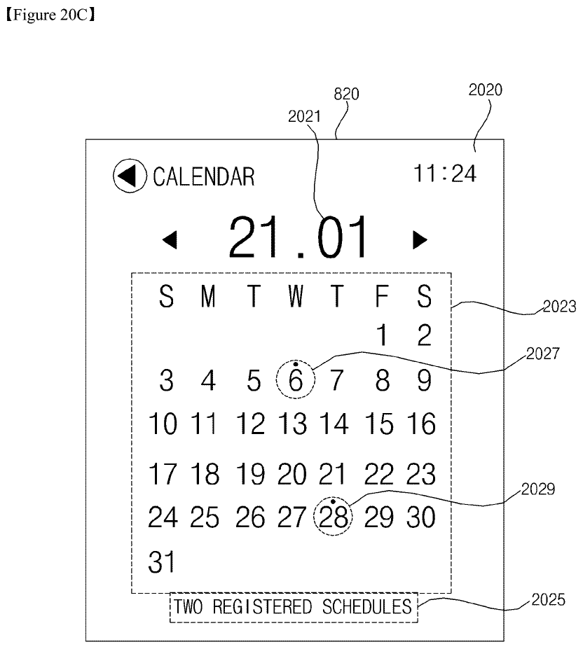

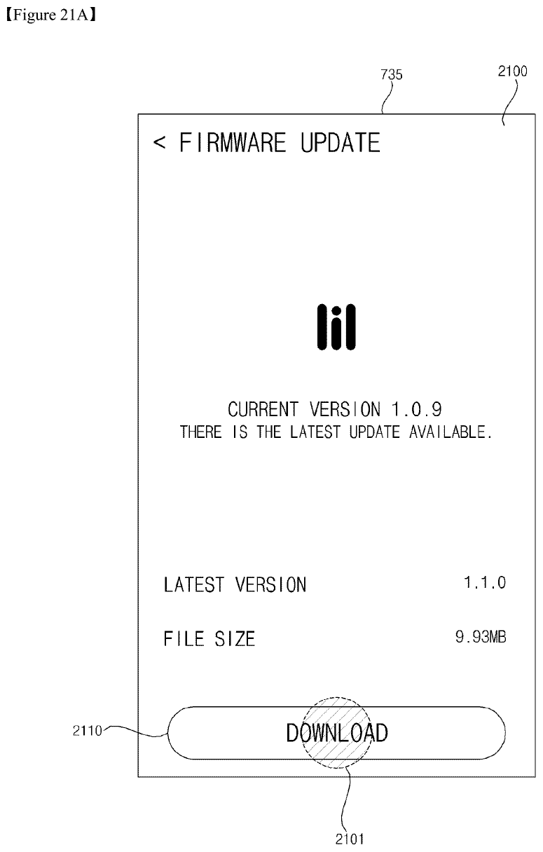

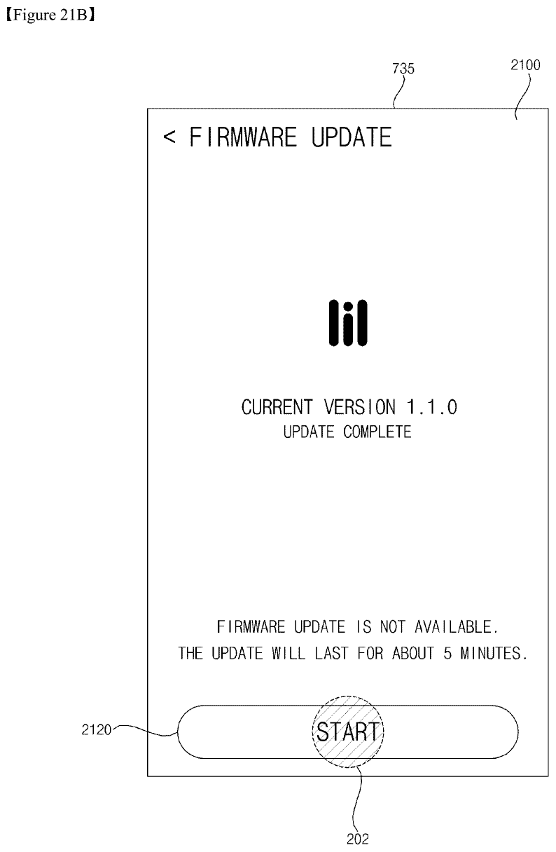

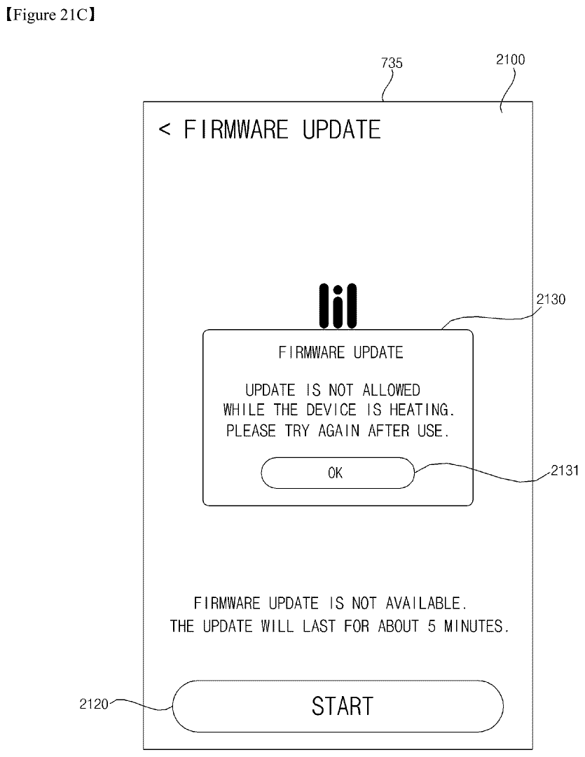

Meanwhile, a user may check whether a communication link is established between the aerosol generating device 10 and the external device 700 based on a screen output through a display included in the aerosol generating device 10. For example, the aerosol generating device 10 may output, through the display, a screen including an indicator corresponding to the communication link. This will be described with reference to FIGS. 9A and 9B.

Referring to FIG. 9A, according to an embodiment of the present disclosure, an insertion space into which a cigarette 20 is inserted may be provided at an upper end of a housing 201 of the aerosol generating device 10.

The insertion space may be recessed into the housing 201 by a predetermined depth, so as to allow at least a portion of the cigarette 20 to be inserted therein. The depth of the insertion space may correspond to the length of a section or portion of the cigarette 20 that contains an aerosol generating substance. For example, when the aerosol generating device 10 is a device capable of using the cigarette 20 of FIG. 5, the depth of the insertion space may correspond to the length of the tobacco rod 21 of the cigarette 20.

The battery 16, a printed circuit board 910, a heater, and the like may be disposed in the housing 201 of the aerosol generating device 10.

Each of the components provided at the aerosol generating device 10 may be mounted on one surface and/or another surface of a printed circuit board 910. The components mounted on the printed circuit board 910 may transmit or receive signals to or from each other through a wiring layer of the printed circuit board 910. For example, at least one communication module included in the communication interface 11, at least one sensor included in the sensor module 15, the controller 17, and the like may be mounted on the printed circuit board 910.

The printed circuit board 910 may be disposed adjacent to the battery 16. For example, the printed circuit board 910 may be disposed such that one surface thereof faces the battery 16.

A temperature sensor may be mounted on one surface of the printed circuit board 910. The temperature sensor may be implemented using a thermistor, which is a device whose resistance changes with temperature, or the like. For example, the temperature sensor may include a negative temperature coefficient thermistor (NTC thermistor) whose resistance decreases as temperature increases.

The controller 17 may determine a temperature of the battery 16 based on a value detected by the temperature sensor. For example, the controller 17 may determine the value detected by the temperature sensor as the temperature of the battery 16. For example, the controller 17 may determine a result value, which is obtained by compensating the value detected by the temperature sensor based on a predetermined reference, as the temperature of the battery 16.

A display 920 may be disposed on one side of the housing 201. The display 920 may display a screen based on a signal transmitted from the controller 17.

A power terminal 930 may be disposed on one side of the housing 201 of the aerosol generating device 10. The power terminal 930 may be a wired terminal for wired communication such as USB.

A power supply circuit (not shown) may be disposed between the battery 16 and the power terminal 930. The power supply circuit may transmit power supplied from the outside to the battery 16 through the power terminal 930.

A power line 935 for supplying power may be connected to the power terminal 930. For example, the power terminal 930 may be coupled to a connector of the power line 935.

The controller 17 may determine whether the power line 935 is connected to the power terminal 930. For example, the controller 17 may determine whether the power line 935 is connected to the power terminal 930 based on a signal generated in response to connection between the power terminal 930 and the power line 935.

When the power line 935 is connected to the power terminal 930, the controller 17 may start charging the battery 16. When the power line 935 is connected to the power terminal 930, the controller 17 may control the operation of each of the components provided at the aerosol generating device 10, so that power supplied through the power line 935 is transmitted to the battery 16. For example, when the power line 935 is connected to the power terminal 930 while the cigarette 20 is inserted into the housing 201, the controller 17 may cut off the supply of power to the aerosol generating module 130, and may start charging of the battery 16.

At least one motor 940 that produces vibration to generate a haptic effect may be disposed in the housing 101. The motor 940 may be mounted on another surface of the printed circuit board 910. For example, the motor 940 may be implemented as a linear actuator or the like, but is not limited thereto.

At least one antenna 950 corresponding to at least one communication module of the communication interface 11 may be disposed in the housing 101. The antenna 950 may be mounted on another surface of the printed circuit board 910.

The structure of the aerosol generating device 10 is not limited to that shown in FIG. 9A, and the arrangement of the battery 16, the printed circuit board 910, the display 920, the power terminal 930, the motor 940, and the antenna 950 may vary according to an embodiment. For example, the motor 940 may be mounted on a board (or substrate) on which the display 920 is disposed.

Referring to FIG. 9B, the display 920 may include a cover glass 921, a display panel 923, and/or a touch panel 925.

The cover glass 921, together with the housing 201, may define an outer appearance of the aerosol generating device 10. The cover glass 921 may come into contact with a part of the body of a user. The cover glass 921 may protect the display panel 923 and/or the touch panel 925 from external impact.

The display panel 923 may be disposed in a direction from the cover glass 921 toward an inside of the housing 201. For example, the display panel 923 may be disposed parallel to the cover glass 921.

The display panel 923 may output an image. The display panel 923 may output an image based on a signal transmitted from the controller 17. For example, the display panel 923 may be implemented as a liquid crystal display (LCD) panel, an organic light emitting diode (OLED) panel, or the like, but is not limited thereto.

The touch panel 925 may be disposed in a direction from the cover glass 921 toward the inside of the housing 201. For example, the touch panel 925 may be disposed parallel to the cover glass 921 and the display panel 923.

The touch panel 925 may detect a touch corresponding to contact of an object. For example, the touch panel 925 may detect a touch corresponding to a touch of a part of the body of the user.

The touch panel 925 may include at least one touch sensor for sensing or detecting a touch. Examples of the touch sensor may include a capacitive touch sensor, a resistive touch sensor, a surface acoustic wave touch sensor, and an infrared touch sensor, but are not limited thereto.

A plurality of touch sensors included in the touch panel 925 may receive a driving signal according to a predetermined period. For example, the plurality of touch sensors included in the touch panel 925 may receive a driving signal according to a predetermined period. Based on the driving signal, the plurality of touch sensors may each output an electrical signal corresponding to a state (e.g., pressure, magnetic field, capacitance, and quantity of light).

The controller 17 may determine whether a touch input is received by monitoring a signal output from the touch panel 925. The controller 17 may perform a determination on a touch input based on the signal output from the touch panel 925. For example, the controller 17 may perform a determination on coordinates of a touch input, a touch area (or region), single touch, multi-touch, the intensity of a touch, and the like. For example, the controller 17 may perform a determination on a long touch input, which is a touch detected for a predetermined time or longer, a short touch input, which is a touch detected for less than the predetermined time, and a swiping (or swipe) touch input in which the position of a touch input is continuously changed in a specific direction.

Meanwhile, the display panel 923 and the touch panel 925 may be configured as one panel. For example, the touch panel 925 may be inserted into the display panel 923 (on-cell type or in-cell type). For example, the touch panel 925 may be added on the display panel 923 (add-on type).

Referring back to FIG. 8, when the communication link is established with the external device 700 through the communication interface 11, the aerosol generating device 10 may check whether user authentication for the user corresponding to the external device 700 is completed in operation S820.

Based on the communication link being established, the aerosol generating device 10 may receive an identifier of the external device 700 from the external device 700. Here, the identifier of the external device 700 may correspond to a serial number, a mac address, and the like, of the external device 700.

In one embodiment, the aerosol generating device 10 may receive the identifier of the external device 700 from the external device 700 while establishing a communication link with the external device 700 through the communication interface 11. In one embodiment, the aerosol generating device 10 may receive the identifier of the external device 700 from the external device 700 through a communication link established with the external device 700.

The aerosol generating device 10 may receive authentication-related data from the external device 700 through the communication link established with the external device 700.

Here, the authentication-related data may include data indicating completion of the user authentication for the user corresponding to the external device 700. In response to receiving the authentication-related data from the external device 700 through the communication link, the aerosol generating device 10 may store data corresponding to the identifier of the external device 700 in the memory 14.

Meanwhile, the user may perform user authentication through the external device 700. For example, the external device 700 may transmit data corresponding to the user to an external server through the communication interface 710. Here, the data corresponding to the user may include a birthday of the user, a unique number representing the user, and the like.

When the data corresponding to the user is valid data for the authentication, the external device 700 may receive data regarding authority to use the aerosol generating device 10 from the external server. In response to receiving the data regarding authority to use the aerosol generating device 10, the external device 700 may transmit data indicating completion of the user authentication to the aerosol generating device 10 through the communication link.

Based on whether data corresponding to the identifier of the external device 700 with which the communication link is established is stored in the memory 14, the aerosol generating device 10 may check whether the user authentication for the user corresponding to the external device 700 is completed. For example, when data corresponding to the identifier of the external device 700 is stored in the memory 14, the aerosol generating device 10 may determine that the user authentication for the user corresponding to the external device 700 is completed.

When the user authentication for the user corresponding to the external device 700 is completed, the aerosol generating device 10 may release a restriction on the use of at least one function in operation S830. For example, when the user authentication for the user corresponding to the external device 700 is completed, the aerosol generating device 10 may release a restriction on the use of a heating function for supplying power to the heater. At this time, based on the restriction on the use of the heating function being released, the aerosol generating device 10 may supply power to the heater.

By contrast, when the communication link is not established with the external device 700 or when the user authentication for the user corresponding to the external device 700 is not completed or done, the aerosol generating device 10 may restrict the use of at least one function in operation S840. For example, when the user authentication for the user corresponding to the external device 700 is not completed, the aerosol generating device 10 may cut off the supply of power to the heater.

Meanwhile, in one embodiment, based on the communication link being disconnected or disabled, the aerosol generating device 10 may restrict the use of at least one function. For example, when the strength of a signal received from the external device 700 is less than a predetermined strength, the aerosol generating device 10 may disconnect the communication link.

Referring to FIGS. 10A and 10B, the aerosol generating device 10 may output a home screen 1000 through the display 920. For example, when the display 920 is turned on from an OFF state, the home screen 1000 may be displayed through the display 920.

The home screen 1000 may include at least one indicator. For example, the home screen 1000 may include an indicator 1010 that indicates an operation mode of the aerosol generating device 10, an indicator 1020 that indicates a communication state, an indicator 1030 that indicates a remaining power capacity of the battery 16, and an indicator 1040 that indicates a current time, and the like.

The indicator 1020 that indicates a communication state may be changed according to the establishment of a communication link between the aerosol generating device 10 and the external device 700.

Referring to FIG. 10A, when the communication link is established between the aerosol generating device 10 and the external device 700, the indicator 1020 indicating a communication state may be displayed as a type (or an icon) corresponding to the communication link.

Referring to FIG. 10B, when the communication link is not established between the aerosol generating device 10 and the external device 700, the indicator 1020 indicating a communication state may be displayed as a type (or an icon) corresponding to communication unavailability.

Referring to FIGS. 11A and 11B, the aerosol generating device 10 may receive a user input through the touch panel 925 while the home screen 1000 is displayed on the display 920.

The aerosol generating device 10 may switch a screen output through the display 920 according to a user input. For example, when user authentication is completed, the aerosol generating device 10 may switch a screen output through the display 920 according to a user input.

In one embodiment, when a swiping touch input 1101 toward the right (or in a right direction) is received while the home screen 1000 is displayed, the aerosol generating device 10 may switch the home screen 1000 displayed through the display 920 to an application screen 1100. In one embodiment, when a touch input 1102 of touching a left edge area of the home screen 1000 is received while the home screen 1000 is displayed, the aerosol generating device 10 may switch the home screen 1000 displayed through the display 920 to the application screen 1100.

The application screen 1100 may include at least one object corresponding to applications installed in the aerosol generating device 10. In this case, when the user touches and selects any one of the objects included in the application screen 1100, the aerosol generating device 10 may execute an application corresponding to the selected object.

Meanwhile, referring to FIG. 11C, when a user input is received in a state where user authentication is not completed or done, the aerosol generating device 10 may output, through the display 920, a message informing that user authentication is required. For example, the aerosol generating device 10 may output a screen including a message informing that user authentication is required as a pop-up screen 1110.

Referring to FIG. 12, the external device 700 may include a display 735. The external device 700 may output a screen through the display 735. In a state where a communication link is established with the aerosol generating device 10, the external device 700 may output, through the display 735, various screens corresponding to functions related to the aerosol generating device 10. In a state where user authentication is completed, the external device 700 may output, through the display 735, various screens corresponding to functions related to the aerosol generating device 10.

Referring to FIGS. 13A and 13B, the external device 700 may output, through the display 735, a setting screen 1300 for determining or editing setting items related to the operation mode, function, state, and the like, of the aerosol generating device 10.

The setting screen 1300 may include a preview object 1310 that indicates the screen type of a currently set home screen of the aerosol generating device 10, and an object 1320 that corresponds to screen types available for setting as the home screen of the aerosol generating device 10, an object 1330 that corresponds to an operation mode (or a usage mode) of the aerosol generating device 10, and the like.

In response to receive a touch input 1301 of selecting an object 1321 that corresponds to a first screen type of the object 1320 corresponding to the screen types included in the setting screen 1300, the external device 700 may output an image corresponding to the first screen type as the preview object 1310.

Meanwhile, based on the touch input 1301 of selecting the object 1321 corresponding to the first screen type, the external device 700 may transmit data corresponding to the type of home screen through the communication link.

Based on the data corresponding to the type of home screen received from the external device 700 through the communication link, the aerosol generating device 10 may update setting information on the home screen. For example, in a state where the user authentication is completed, the aerosol generating device 10 may receive data corresponding to the type of home screen from the external device 700 through the communication link.

Based on the data corresponding to the type of home screen, the aerosol generating device 10 may update the screen type of home screen to the first screen type. In this case, the aerosol generating device 10 may output, through the display 920, a home screen 1325 of the first screen type.

Referring to FIGS. 14A and 14B, the external device 700 may output, through the display 735, the setting screen 1300 for determining setting items of the operation mode, function, state, and the like, of the aerosol generating device 10.

The external device 700 may determine an operation mode of the aerosol generating device 10 based on a user input of selecting at least one of objects 1330 corresponding to the operation modes included in the setting screen 1300. For example, in response to receiving a touch input 1401 of additionally selecting an object corresponding to an operation mode that is not currently set, among the objects 1330 corresponding to the operation modes included in the setting screen 1300, the external device 700 may allow the operation mode selected according to the touch input 1401 to be added to the currently set operation mode of the aerosol generating device 10.

Meanwhile, based on the touch input 1401 of selecting an operation mode, the external device 700 may transmit data corresponding to the operation mode to the aerosol generating device 10 through the communication link.

Based on the data corresponding to the operation mode received from the external device 700 through the communication link, the aerosol generating device 10 may update operation mode of the aerosol generating device 10. For example, in a state where the user authentication is completed, the aerosol generating device 10 may receive data corresponding to the operation mode from the external device 700 through the communication link.

The aerosol generating device 10 may output, through the display 920, a screen 1400 that indicates a currently set operation mode. For example, in a state where two operation modes are set, the aerosol generating device 10 may update the two operation modes to three operation modes based on data corresponding to the operation mode received from the external device 700.

Referring to FIGS. 15A and 15B, the external device 700 may output, through the display 735, a screen 1500 that indicates the state (or status) of the aerosol generating device 10. For example, in a state where the user authentication is completed, the aerosol generating device 10 may transmit state-related data to the external device 700 through the communication link. At this time, based on the state-related data received from the aerosol generating device 10 through the communication link, the external device 700 may display, through the display 735, a remaining power capacity of the battery 16 of the aerosol generating device 10, an operation mode, and the like.

The aerosol generating device 10 may determine the occurrence of an event related to the operation. For example, the aerosol generating device 10 may determine that an event occurs when at least part (e.g., the power terminal 930) of the components is exposed to moisture. For example, the aerosol generating device 10 may determine that an event occurs when the remaining power capacity of the battery 16 is less than a predetermined reference.

The aerosol generating device 10 may transmit data regarding an occurred event in association with the operation to the external device 700. For example, in a state where the user authentication is completed, the aerosol generating device 10 may transmit data regarding an event to the external device 700 through the communication link.

In this case, based on the data regarding the event received from the aerosol generating device 10 through the communication link, the external device 700 may output, through the display 735, a screen corresponding to the occurrence of an event. For example, the aerosol generating device 10 may output a screen including a message informing that at least part of the components (e.g., the power terminal 930) is exposed to moisture as a pop-up screen 1510. For example, the aerosol generating device 10 may output a screen including a message informing that the remaining power capacity of the battery 16 is less than a predetermined reference as a pop-up screen 1520.

Referring to FIGS. 16A and 16B, the external device 700 may perform a function of searching for a location of the aerosol generating device 10. The external device 700 may output, through the display 735, a screen 1600 for searching for a location of the aerosol generating device 10. For example, the external device 700 may output a search screen 1600 for searching for a location of the aerosol generating device 10 while the communication link is established with the aerosol generating device 10. The search screen 1600 may include an object 1605 that starts a search for the location of the aerosol generating device 10.

Based on a touch input 1601 of selecting the object 1605 that starts a search for the location of the aerosol generating device 10, the external device 700 may transmit a search request for the location through the communication link.

Based on the search request received from the external device 700, the aerosol generating device 10 may perform an operation corresponding to the location search of the aerosol generating device 10. For example, in a state where the user authentication is completed, the aerosol generating device 10 may receive a search request from the external device 700 through the communication link.

Based on the search request received from the external device 700, the aerosol generating device 10 may perform an operation corresponding to the location search through at least one of the output devices.

The aerosol generating device 10 may output, through the display 920, a screen 1610 corresponding to the location search. The screen 1610 corresponding to the location search may include an object 1615 corresponding to the close of the search. Based on a touch input of selecting the object 1615 corresponding to the close of the search, the aerosol generating device 10 may finish performing the operation corresponding to the location search of the aerosol generating device 10.

In one embodiment, based on a search request received from the external device 700, the aerosol generating device 10 may generate, through the motor 940, vibration in response to the search request. In one embodiment, based on a search request received from the external device 700, the aerosol generating device 10 may output, through a speaker, audio (or a sound) in response to the search request.

Meanwhile, the aerosol generating device 10 may receive data regarding a notification from the external device 700. For example, in a state where the user authentication is completed, the aerosol generating device 10 may receive notification-related data from the external device 700 through the communication link. Here, the notification-related data may correspond to a function of call connection providing a notification to the user, a function of message reception, and the like.

Referring to FIGS. 17A and 17B, based on data regarding an incoming (phone) call received from the external device 700, the aerosol generating device 10 may output, through the display 920, a screen 1710 corresponding to the incoming call. The screen 1710 corresponding to the incoming call may include an object 1711 that declines the incoming call, an object 1713 that responds to the incoming call with a (text) message, and the like.

Based on a touch input 1701 of selecting the object 1713 that responds to the incoming call with a message, the aerosol generating device 10 may display, through the display 920, a screen 1720 for responding to the incoming call with a message.

The screen 1720 for responding to the incoming call with a message may include at least one object corresponding to a response message to the incoming call. Based on a touch input of selecting any one of objects 1725 corresponding to response messages to the incoming call, the aerosol generating device 10 may transmit a response message corresponding to the selected object to the external device 700 through the communication link.

Referring to FIGS. 18A to 18C, based on data regarding an incoming (text) message received from the external device 700, the aerosol generating device 10 may display, through the display 920, a screen 1810 corresponding to the incoming message. The screen 1810 corresponding to the incoming message may include an object 1811 that declines to respond to the incoming message, an object 1813 that views the incoming message, and the like.

Based on the touch input 1801 of selecting the object 1813 that views the incoming message, the aerosol generating device 10 may output, through the display 920, a screen 1820 that shows the content of the incoming message.

The screen 1820 that shows the content of the incoming message may include an object 1821 that deletes the content of the incoming message, an object 1823 that replies to the incoming message, an object 1825 corresponding to the content of the incoming message, and the like.

Based on a touch input 1803 of selecting the object 1823 that replies to the incoming message, the aerosol generating device 10 may output, through the display 920, a screen 1830 for replying to the incoming message.

The screen 1830 for replying to the incoming message may include at least one object 1835 corresponding to a response message to the incoming message. Based on a touch input of selecting any one of the objects 1835 corresponding to response messages, the aerosol generating device 10 may transmit a response message corresponding to the selected object to the external device 700 through the communication link.

Referring to FIGS. 19A to 19C, the aerosol generating device 10 may switch the screen output through the display 920 according to a user input. For example, when user authentication is completed, the aerosol generating device 10 may switch the screen output through the display 920 according to a user input.

In one embodiment, when a swiping touch input 1901 toward the left (or in a left direction) is received while the home screen 1000 is displayed, the home screen 1000 displayed through the display 920 may be switched to a setting screen 1900. In one embodiment, when a touch input 1902 of touching a right edge area of the home screen 1000 is received while the home screen 1000 is displayed, the aerosol generating device 10 may switch the home screen 1000 displayed through the display 920 to the setting screen 1900.

The setting screen 1900 may include at least one object (hereinafter referred to as a “setting object”) corresponding to setting items related to the operation, function, state, and the like, of the aerosol generating device 10.

When a touch input 1903 of selecting a setting object corresponding to a notification setting is received while the setting screen 1900 is displayed, the aerosol generating device 10 may output, through the display 920, a screen 1920 for determining notification-related setting items.

The screen 1920 for determining notification-related setting items may include a user interface for changing notification-related setting items. For example, the screen 1920 for determining notification-related setting items may include an object 1921 corresponding to inactivation of a notification function, an object 1923 corresponding to inactivation of vibration generation for a notification, and the like.

The aerosol generating device 10 may change a notification-related setting item based on a touch input on an object included in the screen 1920 for determining notification-related setting items.

Referring to FIGS. 20A to 20C, based on a touch input of selecting any one of the objects included in the application screen 1100, the aerosol generating device 10 may execute an application corresponding to the selected object. At this time, the aerosol generating device 10 may execute the application corresponding to the selected object while the user authentication is completed.

In one embodiment, in response to receiving a touch input 2001 of selecting a calendar object 2010, the aerosol generating device 10 may execute an application corresponding to the calendar object 2010 (hereinafter referred to as a “calendar application”).

When executing the calendar application, the aerosol generating device 10 may request the external device 700 to transmit data regarding a schedule through the communication link. For example, the aerosol generating device 10 may request the external device 700 to transmit data regarding a one-month schedule corresponding to a current date through the communication link.

Based on the data regarding the schedule received from the external device 700 through the communication link, the aerosol generating device 10 may output, through the display 920, a screen 2020 corresponding to the calendar application.

The screen 2020 corresponding to the calendar application may include an object 2021 that indicates a specific year and month, an object 2023 that indicates a calendar of a specific year and month, and the like.

When data, which is received from the external device 700 through the communication link, contains a schedule of a specific year and month, the aerosol generating device 10 may allow an indicator corresponding to the schedule of the specific year and month to be included in the screen 2020 corresponding to the calendar application. For example, the indicator corresponding to the schedule of the specific year and month may include an indicator 2025 that indicates the number of schedules registered on the specific year and month, indicators 2027 and 2029 that respectively indicate dates on which schedules are registered, and the like.

Meanwhile, when the user selects, through a touch input, any one of the dates included in the object 2023 that indicates a calendar of a specific year and month, the aerosol generating device 10 may output, through the display 920, a screen including a schedule registered on the selected date. For example, the aerosol generating device 10 may switch the screen 2020 corresponding to the calendar application to a screen including a schedule registered on a selected date. For example, the aerosol generating device 10 may output a screen including a schedule registered on a selected date as a pop-up screen while the screen 2020 corresponding to the calendar application is output.

Referring to FIGS. 21A to 21E, the external device 700 may output, through the display 735, a screen 2100 corresponding to an update of firmware of the aerosol generating device 10.

In one embodiment, the screen 2100 corresponding to a firmware update may include an object 2110 for downloading data corresponding to a new (latest) version of the firmware of the aerosol generating device 10.

The external device 700 may check a current version of the firmware of the aerosol generating device 10. For example, the external device 700 may check the current version of the firmware of the aerosol generating device 10 based on an update history of the firmware of the aerosol generating device 10. For example, the external device 700 may check the current version of the firmware of the aerosol generating device 10 based on data received from the aerosol generating device 10 through the communication interface 710.

The external device 700 may determine whether there is a new version different from the current version of the firmware of the aerosol generating device 10 based on data received from an external server through the communication interface 710.

In response to receiving a touch input 2101 of selecting the object 2110 for data download, the external device 700 may receive data corresponding to the new version of the firmware through the communication interface 710. For example, in response to receiving the touch input 2101 of selecting the object 2110 for data download, the external device 700 may request the external server to transmit data corresponding to the new version through the communication interface 710.

In response to receiving the data corresponding to the new version of the firmware, the external device 700 may change an object included in the screen 2100 corresponding to a firmware update. For example, the screen 2100 corresponding to a firmware update may include a message indicating that the reception of data corresponding to the latest version of the firmware is complete, an object 2120 that starts an update of the firmware of the aerosol generating device 10, and the like.

In response to receiving a touch input 2102 of selecting the object 2120 that starts an update of the firmware of the aerosol generating device 10, the external device 700 may transmit data corresponding to the new version of the firmware to the aerosol generating device 10 through the communication link.

In one embodiment, an update of the firmware of the aerosol generating device 10 may be stopped while the aerosol generating device 10 performs an operation of heating the heater. For example, the external device 700 may check, through the communication link, the operation currently performed by the aerosol generating device 10. When the aerosol generating device 10 performs the operation of heating the heater, the external device 700 may stop transmission of data corresponding to the new version of the firmware.

The external device 700 may output a message notifying that a firmware update is not allowed when the aerosol generating device 10 performs the operation of heating the heater. For example, the external device 700 may output a pop-up screen 2130 including a message informing that the firmware update is unavailable. The pop-up screen 2130 may include an object 2131 that closes or terminates the output of the pop-up screen 2130, and the like.

Meanwhile, the external device 700 may change an object included in the screen 2100 corresponding to a firmware update based on completion of the firmware update of the aerosol generating device 10. For example, the screen 2100 corresponding to a firmware update may include a message indicating a current version of the firmware of the aerosol generating device 10, a message indicating completion of the firmware update, and an object that terminates the output of the screen 2100 corresponding to a firmware update.

In one embodiment, the external device 700 may output a screen 2140 related to a new (latest) version of the firmware while the screen 1500 that displays the state of the aerosol generating device 10 is output through the display 735. For example, the external device 700 may output the screen 2140 related to a new version of the firmware as a pop-up screen.

The screen 2140 related to a new version of the firmware may include an object 2141 that delays the firmware update, an object 2143 that proceeds the firmware update, and the like.

In response to receiving a touch input 2103 of selecting the object 2143 that proceeds the firmware update, the external device 700 may output, through the display 735, the screen 2100 corresponding to a firmware update of the aerosol generating device 10.

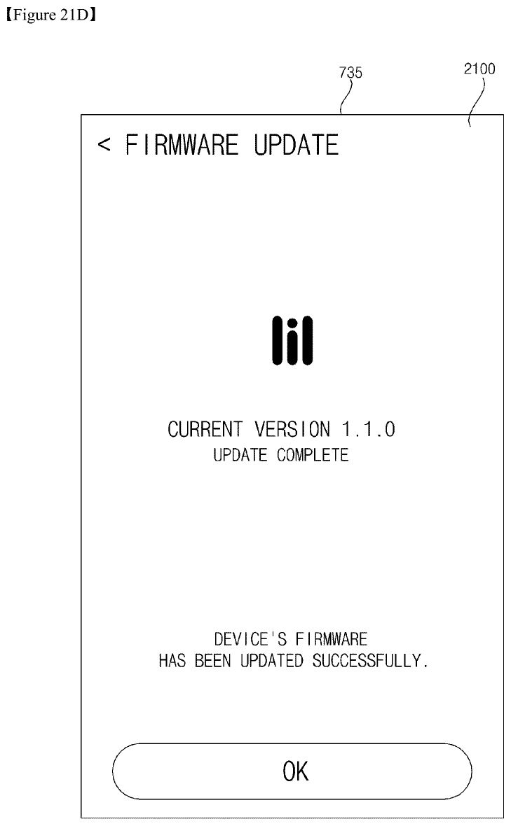

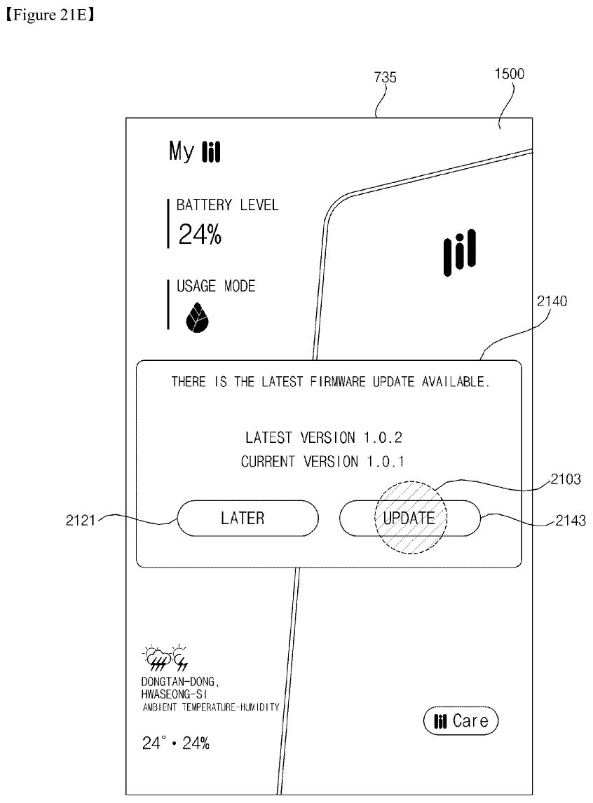

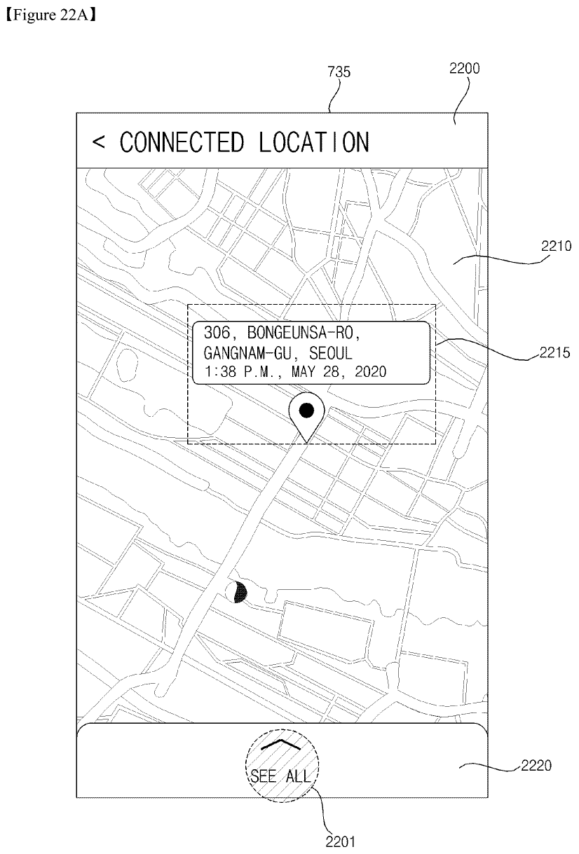

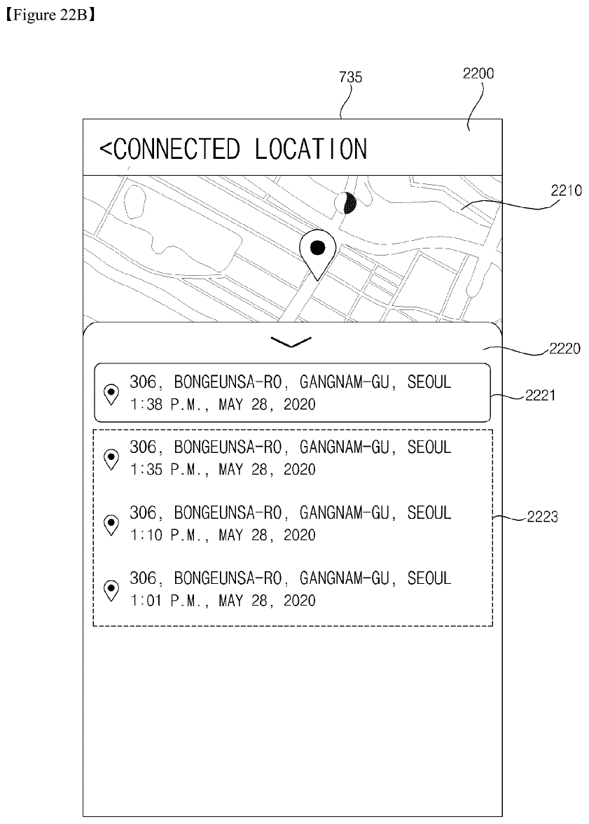

Referring to FIGS. 22A and 22B, the external device 700 may output, through the display 735, a screen 2200 that shows a location of the aerosol generating device 10.

The screen 2200 that shows a location of the aerosol generating device 10 may include a map 2210 according to the location of the aerosol generating device 10, an indicator 2215 including information of the location of the aerosol generating device 10, an object 2220 corresponding to detailed content of the location of the aerosol generating device 10, and the like.

In one embodiment, based on a communication link to the aerosol generating device 10 being disconnected, the external device 700 may store data corresponding to a location of the external device 700 in the memory 720. For example, the data corresponding to the location of the external device 700 may include a time point at which the communication link is disconnected, a location of the external device 700 when the communication link is disconnected, and the like. Here, the location of the external device 700 may be determined based on a signal received through the antenna 715 corresponding to the GPS.

In response to receiving a touch input 2201 of selecting the object 2220 corresponding to detailed content of the location of the aerosol generating device 10, the aerosol generating device 10 may display and enlarge an area corresponding to detailed content of the location of the aerosol generating device 10. At this time, an area corresponding to the map 2210 according to the location of the aerosol generating device 10 may be displayed in a reduced size.

Based on the area corresponding to the object 2220 corresponding to detailed content of the location of the aerosol generating device 10 being enlarged, the external device 700 may allow the detailed content of the location of the aerosol generating device 10 to be included in the screen 2200 that shows a location of the aerosol generating device 10. For example, the detailed content of the location of the aerosol generating device 10 may include content 2221 corresponding to the latest disconnection of the communication link and/or content 2223 corresponding to the previous disconnection of the communication link.

Based on data corresponding to a location of the external device 700 stored in the memory 720, the external device 700 may determine detailed content of the location of the aerosol generating device 10.

As described above, according to at least one of the embodiments of the present disclosure, the use by a third party who does not have access to the aerosol generating device 10 may be restricted.

According to at least one of the embodiments of the present disclosure, a user may be provided with not only a function of generating an aerosol, but also various convenience functions.

According to at least one of the embodiments of the present disclosure, a user may be provided with a convenience function using a communication link established between the aerosol generating device 10 and the external device 700.

Referring to FIGS. 1 to 22B, an aerosol generating device 10 according to one aspect of the present disclosure may include: a heater configured to heat an aerosol generating substance; a communication interface 11 to perform communication with an external device 700; and a controller 17. The controller 17 may be configured to: in a state where a communication link is established with the external device 700 through the communication interface 11, check whether authentication for a user is completed; based on the authentication not being completed, restrict use of at least one function including a heating function that supplies power to the heater; and based on the authentication being completed, release a restriction on the use of the at least one function.

According to another aspect of the present disclosure, the controller 17 may be configured to, based on the communication link being disconnected, restrict the use of the at least one function.

According to another aspect of the present disclosure, the aerosol generating device 10 may further include a memory 14 configured to store therein data regarding the authentication. The controller 17 may be configured to: receive, through the communication interface 11, an identifier corresponding to the external device 700 from the external device 700; and determine whether the authentication is completed based on whether data corresponding to the identifier is stored in the memory 14.

According to another aspect of the present disclosure, the controller 17 may be configured to, based on data regarding the authentication received from the external device 700 through the communication link, store data corresponding to the identifier in the memory 14.

According to another aspect of the present disclosure, the aerosol generating device 10 may further include a motor 940 configured to generate vibration. The controller 17 may be configured to, in a state where the authentication is completed, based on a search request received from the external device 700 through the communication link, output, through the motor 940, vibration in response to the search request.

According to another aspect of the present disclosure, the controller 17 may be configured to, in a state where the authentication is completed, update setting information on the aerosol generating device 10 based on data regarding a setting received from the external device 700 through the communication link.

According to another aspect of the present disclosure, the controller 17 may be configured to, in a state where the authentication is completed, based on an occurrence of an event in association with an operation, transmit data regarding the event to the external device 700 through the communication link.

According to another aspect of the present disclosure, the aerosol generating device 10 may further include: a display panel 923 configured to output a screen; and a touch panel 925 configured to receive a user input. The controller 17 may be configured to: in a state where the authentication is completed, in response to receiving a user input of executing a specific function among the at least one function, request the external device 700 to transmit data corresponding to the specific function through the communication link; and based on the data corresponding to the specific function received from the external device 700 through the communication link, output, through the display panel 923, a screen corresponding to the specific function.

According to another aspect of the present disclosure, the aerosol generating device 10 may further include a display 920. The controller 17 may be configured to, in a state where the authentication is completed, based on data regarding a notification received from the external device 700 through the communication link, output, through the display 920, a screen corresponding to the notification.

According to another aspect of the present disclosure, the aerosol generating device 10 may further include a display panel 923 configured to output a screen; and a touch panel 925 configured to receive a user input. The controller 17 may be configured to: in a state where the authentication is completed, based on data regarding a notification received from the external device 700 through the communication link, output, through the display panel 923, a screen corresponding to at least one preset response to the notification; and based on a user input of selecting one of the at least one preset response through the touch panel 925, transmit data regarding the selected response to the external device 700 through the communication link.

A system according to one aspect of the present disclosure may include an aerosol generating device 10 and an external device 700. The aerosol generating device 10 may include a first communication interface 11 to perform communication with the external device 700, and the external device 700 may include a second communication interface 710 to perform communication with the aerosol generating device 710 and a memory 720. The aerosol generating device 10 may be configured to: in a state where a communication link is established with the external device 700 through the first communication interface 11, check whether authentication for a user is completed; based on the authentication not being completed, restrict use of at least one function; and based on the authentication being completed, release a restriction on the use of the at least one function.

According to another aspect of the present disclosure, the external device 700 may be configured to, based on a communication link to the aerosol generating device 10 being disconnected, store data corresponding to a location of the external device 700 in the memory 720.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol generating device comprising:
a heater configured to heat an aerosol generating substance according to power supplied to the heater;
a communication interface; and
a controller configured to:
identify whether authentication for a user is completed or is not completed, in a state where a communication link is established with an external device through the communication interface;
restrict use of at least one function, including a heating function that permits the power to be supplied the heater, based on the authentication being not completed; and
release a restriction on the use of the at least one function, based on the authentication being completed.

2. The aerosol generating device of claim 1, wherein the controller is further configured to restrict the use of the at least one function, based on the communication link being disconnected.

3. The aerosol generating device of claim 1, further comprising a memory configured to store data regarding the authentication,
wherein the controller is further configured to:
receive from the external device, through the communication interface, an identifier corresponding to the external device; and
determine whether the authentication is completed based on whether data corresponding to the identifier is stored in the memory.

4. The aerosol generating device of claim 3, wherein the controller is further configured to store the data corresponding to the identifier in the memory, based on the data regarding the authentication being received from the external device through the communication link.

5. The aerosol generating device of claim 1, further comprising a motor configured to generate vibration,
wherein the controller is further configured to, in a state where the authentication is completed, cause the motor to generate the vibration in response to a search request received from the external device through the communication link.

6. The aerosol generating device of claim 1, wherein the controller is further configured to, in a state where the authentication is completed, update setting information for the aerosol generating device, based on data regarding a setting received from the external device through the communication link.

7. The aerosol generating device of claim 1, wherein the controller is further configured to, in a state where the authentication is completed, cause the communication interface to transmit data regarding an event to the external device, based on an occurrence of the event in association with an operation.

8. The aerosol generating device of claim 1, further comprising:
a display; and
a touch panel configured to receive a user input,
wherein the controller is further configured to:
in a state where the authentication is completed, control the communication interface to send a request to the external device to transmit data corresponding to a specific function, in response to receiving the user input for executing the specific function among the at least one function; and
cause the display to display a screen corresponding to the specific function, based on the data corresponding to the specific function being received from the external device through the communication link.

9. The aerosol generating device of claim 1, further comprising a display,
wherein the controller is further configured to, in a state where the authentication is completed, cause the display to display a screen corresponding to a notification, based on data regarding the notification being received from the external device through the communication link.

10. The aerosol generating device of claim 1, further comprising:
a display; and
a touch panel configured to receive a user input,
wherein the controller is further configured to:
in a state where the authentication is completed, cause the display to display a screen corresponding to at least one preset response to a notification, based on data regarding the notification being received from the external device through the communication link; and
control the communication interface to transmit data regarding a selected response to the external device, based on a user input selecting one of the at least one preset response through the touch panel.

11. A system comprising:
an aerosol generating device; and
an external device,
wherein the aerosol generating device comprises a first communication interface configured to perform communication with the external device,
wherein the external device comprises:
a second communication interface configured to perform communication with the aerosol generating device; and
a memory, and
wherein the aerosol generating device is configured to:
identify whether authentication for a user is completed or is not completed, in a state where a communication link is established with the external device through the first communication interface;
restrict use of at least one function, based on the authentication being not completed; and
release a restriction on the use of the at least one function, based on the authentication being completed.

12. The system of claim 11, wherein the external device is configured to, store data corresponding to a location of the external device in the memory, based on a communication link to the aerosol generating device being disconnected.
